(19) United States
(12) Patent Application Publication
(10) Pub. No.: US 2025/0270133 A1
(43) Pub. Date: Aug. 28, 2025

(54) GLASS MEMBER AND GLASS MEMBER LAMINATE, INPUT DEVICE, INPUT DISPLAY DEVICE, GLASS MEMBER FOR EXTERIOR USE, HOUSING, DOOR BODY, CONTAINER, AND METHOD FOR MANUFACTURING GLASS MEMBER

(71) Applicant: NIPPON ELECTRIC GLASS CO., LTD., Otsu-shi, Shiga (JP)

(72) Inventors: Naoki FUJITA, Otsu-shi, Shiga (JP); Takumi KINOSHITA, Otsu-shi, Shiga (JP)

(21) Appl. No.: 18/685,298

(22) PCT Filed: Aug. 22, 2022
(86) PCT No.: PCT/JP2022/031544

§ 371 Date: Aug. 15, 2024

(30) Foreign Application Priority Data
Aug. 25, 2021 (JP) 2021-137358

(51) Int. Cl. C03C 15/00; B24C 1/04; G06F 3/01; G06F 3/041

(52) U.S. Cl. CPC C03C 15/00; B24C 1/04; G06F 3/016; G06F 3/041

(57) ABSTRACT

Provided are: a glass member that excels in tactile sensation such as the feel of writing and the feel of touch; a glass member laminate; an input device; an input display device; a glass member for exterior use; a housing; a door body; a container; and a method for manufacturing the glass member. In first irregularities, the arithmetic mean height Sa1 is 2-500 nm and the mean width RSm1 of roughness profile elements is 2-100 μm when it is assumed that the cutoff value of a high-pass filter λc1 is 14 μm and the cutoff value of a low-pass filter λs1 is 0.35 μm. In second irregularities, the arithmetical mean height Sa2 in a square region with one side measuring 5 μm is 0.7-50 nm when it is assumed that the cutoff value of a high-pass filter λc2 is 2.5 μm.

### TECHNICAL FIELD

The present invention relates to a glass member and a glass member laminate, an input device, an input display device, a glass member for exterior use, a housing, a door body, and a container, each including the glass member and a technique of a method for manufacturing the glass member.

### BACKGROUND ART

Conventionally, an input device such as a touch panel is known, which allows an input operation of characters, graphics, and the like to be performed with an input pen or a fingertip.

In such an input device, a cover member made of a transparent glass member such as a glass substrate is disposed on a forward side (front side) of a display device such as a liquid-crystal display, and various input operations can be performed by touching and moving an input pen or a fingertip on the surface (principal surface) of the cover member.

Here, in general, the surface of the cover member is provided with irregularities in advance for the purpose of, for example, improving tactile sensations such as a feel of writing with an input pen or a feel of touch with a fingertip, or ensuring the visibility of the display device through the cover member.

In recent years, there has been an increasing demand for tactile sensations of higher quality.

As a technique for further improving tactile sensations, for example, Patent Literature 1 discloses a touch panel surface member that has a surface with irregularities, the irregularities satisfying the following conditions, i.e., 0.08 μm≤Ra_{0.25}≤1.35 μm and 0.11< [RΔq_{2.5}/RΔq_{0.025}]≤0.80, here, Ra_{0.25}: an arithmetical mean roughness according to JIS B0601: 2001 with a cutoff value of 0.25 mm, RΔq_{2.5}: a root mean square gradient of roughness curve according to JIS B0601: 2001 with a cutoff value of 2.5 mm, and RΔq_{0.025}: a root mean square gradient of roughness curve according to JIS B0601: 2001 with a cutoff value of 0.025 mm.

Patent Literature 2 discloses a pen input device cover glass that has a haze value of less than 1% and has fine irregularities whose Martens hardness is in a range of 2000-4000 N/mm².

### CITATIONS LIST

### Patent Literatures

Patent Literature 1: JP-A 6819446 Gazette
Patent Literature 2: WO 2015/072297 A1 Gazette

### SUMMARY OF INVENTION

### Technical Problems

However, the touch panel surface member disclosed in Patent Literature 1 has relatively large irregularities on the surface, and thus, although some improvement in the feel of writing with an input pen can be expected, it is difficult to achieve high-quality tactile sensations because the feel of touch with a fingertip is rough.

It is also difficult to maintain sufficient visibility because the haze value is high and the screen of the display device appears white through the surface.

In the cover glass disclosed in Patent Literature 2, the haze value is suppressed by the fine irregularities formed on the surface, which can ensure sufficient visibility. However, such uniform irregularities may cause too much frictional force when a user touches with and moves an input pen or a fingertip, and the tactile sensations such as the feel of writing with an input pen and the feel of touch with a fingertip may deteriorate. The present invention has been made in view of the current issues indicated above, and the problem of the present invention is to provide: a glass member that excels in tactile sensation such as the feel of writing with an input pen and the feel of touch with a fingertip; a glass member laminate, an input device, an input display device, a glass member for exterior use, a housing, a door body, and a container, each including the glass member; and a method for manufacturing the glass member.

### Solutions to Problems

The problem to be solved by the present invention is as the above, and aspects for solving the problem are described below.

A glass member according to aspect 1 of the present invention has a principal surface with irregularities, the irregularities including: first irregularities in which the arithmetical mean height Sa1 is 2-500 nm and the mean width RSm1 of roughness curve elements is 2-100 μm when it is assumed that the cutoff value of a high-pass filter λc1 is 14 μm and the cutoff value of a low-pass filter λs1 is 0.35 μm; and second irregularities in which the arithmetical mean height Sa2 in a square region with one side measuring 5 μm is 0.7-50 nm when it is assumed that the cutoff value of a high-pass filter λc2 is 2.5 μm.

With such a configuration, according to the glass member of the present invention, in a case where an input operation is performed with an input pen on the principal surface, a pen tip of the input pen is neither excessively unlikely to slide nor excessively likely to slide, and thus, it is possible to improve the feel of writing with the input pen.

In addition, it is possible to improve the feel of touch with a fingertip without a feel of excessive roughness in a case where an operation is performed with the fingertip on the principal surface.

It is preferable that a glass member according to aspect 2 of the present invention is the glass member according to aspect 1 in which in the first irregularities, when the cutoff value of the high-pass filter λc1 is 14 μm and the cutoff value of the low-pass filter λs1 is 0.35 μm, a maximum height roughness Rz1 is 25-700 nm.

With such a configuration, according to the glass member of the present invention, in a case where an input operation is performed with the input pen and the fingertip on the principal surface, the friction force transmitted to the pen tip of the input pen and the fingertip through the first irregularities and the second irregularities appropriately repeats increase and decrease, and the feel of writing with the input pen and the feel of touch with the fingertip can be still further improved.

A glass member according to aspect 3 of the present invention has a principal surface with irregularities, the irregularities including: first irregularities in which the arithmetical mean height Sa1 is 2-500 nm and the mean width RSm1 of roughness curve elements is 2-100 μm when it is assumed that the cutoff value of the high-pass filter λc1 is 50 μm and the cutoff value of the low-pass filter λs1 is 0.35 μm; and second irregularities in which the arithmetical mean height Sa2 in a square region with one side measuring 5 μm is 0.7-50 nm when it is assumed that the cutoff value of the high-pass filter λc2 is 2.5 μm.

With such a configuration, according to the glass member of the present invention, in a case where an input operation is performed with an input pen on the principal surface, a pen tip of the input pen is neither excessively unlikely to slide nor excessively likely to slide, and thus, it is possible to improve the feel of writing with the input pen.

In addition, it is possible to improve the feel of touch with a fingertip without a feel of excessive roughness in a case where an operation is performed with the fingertip on the principal surface.

It is preferable that a glass member according to aspect 4 of the present invention is the glass member according to aspect 3 in which in the first irregularities, when the cutoff value of the high-pass filter λc1 is 50 μm and the cutoff value of the low-pass filter λs1 is 0.35 μm, a maximum height roughness Rz1 is 25-1500 nm.

With such a configuration, according to the glass member of the present invention, in a case where an input operation is performed with the input pen and the fingertip on the principal surface, the friction force transmitted to the pen tip of the input pen and the fingertip appropriately repeats increase and decrease, and the feel of writing with the input pen and the feel of touch with the fingertip can be still further improved.

It is preferable that a glass member according to aspect 5 of the present invention is the glass member according to any one of aspects 1 to 4 in which in the second irregularities, a developed interfacial area ratio Sdr2 in a square region with one side measuring 5 μm is 3-60% when the cutoff value of the high-pass filter λc2 is assumed to be 2.5 μm.

With such a configuration, according to the glass member of the present invention, it is possible to further improve the feel of writing with the input pen and the feel of touch with the fingertip.

It is preferable that a glass member according to aspect 6 of the present invention is the glass member according to any one of aspects 1 to 5 in which in the second irregularities, a root mean square gradient Sdq2 in a square region with one side measuring 5 μm is 2-80 when the cutoff value of the high-pass filter λc2 is assumed to be 2.5 μm.

With such a configuration, according to the glass member of the present invention, it is possible to further improve the feel of writing with the input pen and the feel of touch with the fingertip.

It is preferable that a glass member according to aspect 7 of the present invention is the glass member according to any one of aspects 1 to 6 in which in the second irregularities, a maximum height Sz2 in a square region with one side measuring 5 μm is 10-400 nm when the cutoff value of the high-pass filter λc2 is assumed to be 2.5 μm.

With such a configuration, according to the glass member of the present invention, in a case where an input operation is performed with the input pen and the fingertip on the principal surface, the friction force transmitted to the pen tip of the input pen and the fingertip through the first irregularities and the second irregularities appropriately repeats increase and decrease, and the feel of writing with the input pen and the feel of touch with the fingertip can be still further improved.

It is preferable that a glass member according to aspect 8 of the present invention is the glass member according to any one of aspects 1 to 7 in which in the second irregularities, a maximum peak height Sp2 in a square region with one side measuring 5 μm is 6-200 nm when the cutoff value of the high-pass filter λc2 is assumed to be 2.5 μm.

With such a configuration, according to the glass member of the present invention, it is possible to still further improve the feel of writing with the input pen and the feel of touch with the fingertip.

A glass member laminate according to aspect 9 of the present invention includes: the glass member according to any one of aspects 1 to 8; and an antifouling layer that is provided on at least a part of the principal surface of the glass member.

With such a configuration, it is possible to achieve a glass member laminate that excels in tactile sensation such as the feel of writing with an input pen and the feel of touch with a fingertip, and has an antifouling function.

An input device according to aspect 10 of the present invention includes: the glass member according to any one of aspects 1 to 8 or the glass member laminate according to aspect 9; and a detection circuit that detects an input position.

With such a configuration, it is possible to achieve an input device that excels in tactile sensation such as the feel of writing with an input pen and the feel of touch with a fingertip, or an input device that further has an antifouling function.

An input display device according to aspect 11 of the present invention includes: the input device according to aspect 10; and a display device.

With such a configuration, it is possible to achieve an input display device that excels in tactile sensation such as the feel of writing with an input pen and the feel of touch with a fingertip, or an input display device that further has an antifouling function.

A glass member for exterior use according to aspect 12 of the present invention is constituted of the glass member according to any one of aspects 1 to 8 or the glass member laminate according to aspect 9.

With such a configuration, it is possible to achieve a glass member for exterior use that excels in tactile sensation such as the feel of touch with a fingertip, or a glass member for exterior use that further has an antifouling function.

A housing according to aspect 13 of the present invention includes the glass member for exterior use according to aspect 12.

With such a configuration, it is possible to achieve a housing that excels in tactile sensation such as the feel of touch with a fingertip, or a housing that further has an antifouling function.

A door body according to aspect 14 of the present invention includes the glass member for exterior use according to aspect 12.

With such a configuration, it is possible to achieve a door body that excels in tactile sensation such as the feel of touch with a fingertip, or a door body that further has an antifouling function.

A container according to aspect 15 of the present invention includes the glass member for exterior use according to aspect 12.

With such a configuration, it is possible to achieve a container that excels in tactile sensation such as the feel of touch with a fingertip, or a container that further has an antifouling function.

A method for manufacturing glass member according to the present invention is for manufacturing the glass member according to any one of aspects 1 to 8, the method including: a first forming step of forming the first irregularities by performing a hydrofluoric acid etching on the principal surface of the glass member; and a second forming step of forming the second irregularities by performing a wet blast treatment or a sand blast treatment on the first irregularities formed in the first forming step.

With such a configuration, according to the method for manufacturing glass member of the present invention, in a case where an input operation is performed with the input pen on the principal surface, the pen tip of the input pen is neither excessively unlikely to slide nor excessively likely to slide, and thus, it is possible to manufacture the glass member with an excellent feel of writing with the input pen.

In addition, it is possible to manufacture the glass member with an excellent feel of touch with the fingertip and without a feel of excessive roughness in a case where an input operation is performed with the fingertip on the principal surface.

### Advantageous Effects of Invention

The present invention has the following effects.

That is, according to the glass member, the glass member laminate, the input device, the input display device, the glass member for exterior use, the housing, the door body, and the container, each including the glass member, and the method for manufacturing the glass member of the present invention, it is possible to improve tactile sensations such as the feel of writing with an input pen and the feel of touch with a fingertip.

### BRIEF DESCRIPTION OF DRAWINGS

FIG. 1 is a schematic cross-sectional side view illustrating a configuration of an input display device according to one embodiment of the present invention.

FIG. 2 is a diagram for illustrating a measurement cross-sectional curve on a principal surface of a glass member, and is a schematic enlarged cross-sectional view showing shapes of first irregularities and second irregularities.

FIGS. 3A and 3B are diagrams for illustrating various parameters representing roughness of the irregularities, in which FIG. 3A is a schematic diagram for illustrating various parameters in surface roughness, and FIG. 3B is a schematic diagram for illustrating various parameters in line roughness.

FIG. 4 is a graph showing a relation between wavelength and amplitude transfer rate, and is for illustrating cutoff values of a high-pass filter λc1 and a low-pass filter λs1.

FIGS. 5A and 5B are diagrams for illustrating a reason for setting an upper limit in an mean width RSm1 of roughness curve elements in the first irregularities, in which FIG. 5A is a schematic diagram for a case where RSm1 exceeds 100 μm, and FIG. 5B is a schematic diagram for a case where RSm1 is 100 μm or less.

FIGS. 6A and 6B are diagrams for illustrating parameters representing surface roughness, which are developed interfacial area ratio Sdr and root mean square gradient Sdq, in which FIG. 6A is a schematic diagram showing a case where a defined region is a completely flat surface, and FIG. 6B is a schematic diagram showing a case where a defined region is a corrugated plane with slopes.

FIG. 7 is a process diagram showing a method for manufacturing glass member according to one embodiment of the present invention.

FIGS. 8A to 8C are diagrams showing one example of another embodiment of the present invention, in which FIG. 8A is a schematic diagram showing one example of an electronic device including a housing constituted of a glass member for exterior use, FIG. 8B is a schematic diagram showing one example of an electronic device including a housing and a door body constituted of a glass member for exterior use, and FIG. 8C is a schematic diagram showing one example of a container including a glass member for exterior use.

FIG. 9 is a schematic cross-sectional side view showing another configuration of the input display device according to one embodiment of the present invention.

### DESCRIPTION OF EMBODIMENTS

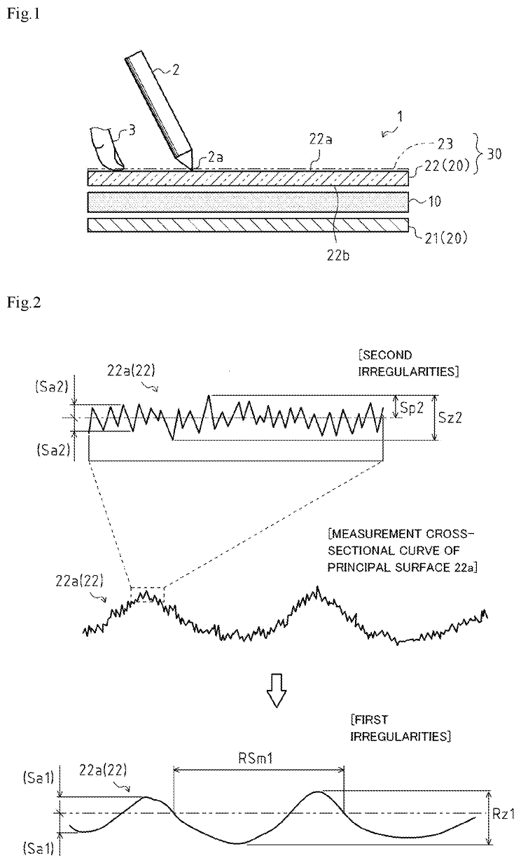

Next, one embodiment of the present invention will be described with reference to FIGS. 1 to 9.

### [Overall Configuration of Input Display Device 1]

First, the overall configuration of an input display device 1 embodied by the present embodiment will be described with reference to FIG. 1.

The input display device 1 mainly includes a display element 10 as one example of a display device for displaying an image, and an input device 20 to which information such as characters and graphics is input by an input pen 2 or a fingertip 3.

The input device 20 includes a digitizer circuit 21, which is one example of a detection circuit that detects the information (more specifically, an input position of the input pen 2 or the fingertip 3), a glass substrate 22, which is one example of a glass member and is provided as a cover member, and the like.

The display element 10, the digitizer circuit 21, and the glass substrate 22 are stacked on one another, the glass substrate 22 is disposed on a front side of the display element 10, and the digitizer circuit 21 is disposed on a rear side of the display element 10.

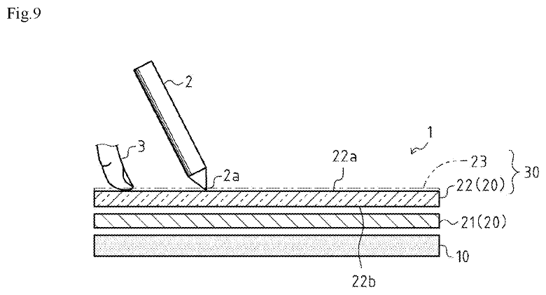

As shown in FIG. 9, the digitizer circuit 21 and the glass substrate 22 may be disposed on the front side of the display element 10, or the digitizer circuit 21 may be integrated with the display element 10 as a built-in type. The input device 20 may include one digitizer circuit 21 or two or more digitizer circuits 21.

In the above description, the “front side” of the display element 10 is a side on which an image is displayed, and the “rear side” of the display element 10 means a side opposite to the side on which the image is displayed.

In the present embodiment, for example, the “front side” of the display element 10 is the upper side of the paper surface in FIG. 1, and the “rear side” of the display element 10 is the lower side of the paper surface in FIG. 1.

The input display device 1 is configured such that when a pen tip 2a of the input pen 2 or the fingertip 3 is moved in contact with a principal surface 22a of the glass substrate 22 (the surface of the glass substrate 22 opposite to the display element 10), the digitizer circuit 21 detects the position of the pen tip 2a or the fingertip (input position), and enables input operation of characters, graphics, and the like.

Examples of the input display device 1 include, for example, a tablet terminal.

The tablet terminal broadly means an input display device having both display and input functions, and includes devices such as a tablet PC, a mobile PC, a smartphone, and a game machine.

The glass substrate 22 is formed of a transparent glass plate having irregularities on at least one principal surface (the principal surface 22a in the present embodiment).

The glass substrate 22 is disposed in a manner that the principal surface 22a having the irregularities thereon is a surface on the side with which the input pen 2 or the fingertip 3 comes into contact.

Here, as the glass substrate 22, for example, a glass plate made of aluminosilicate glass, borosilicate glass, alkali-free glass, soda-lime glass, tempered glass, Li₂O—Al₂O₃—SiO₂ crystallized glass, or the like can be used.

In addition, in a case where the glass substrate 22 is formed of a glass plate made of alkali-containing aluminosilicate glass, the glass substrate 22 may have a chemically strengthened layer on the surface thereof.

The glass substrate 22 will be described in detail later.

The digitizer circuit 21 includes a detection sensor for detecting an input operation by the input pen 2 or the fingertip 3.

The input pen 2 is an input tool having a shape similar to writing tools such as pencils and ball pens, and has a pen tip 2a which is one example of a friction element that comes into contact with the glass substrate 22. The pen tip 2a is made of synthetic resins such as elastomers and polyacetals, or conductive fibers, felts, or the like.

For the input pen 2, the pen tip 2a made of the above-described member is more likely to be caught by the irregularities.

Therefore, in a case where the pen tip 2a of the input pen 2 is moved in contact with the principal surface 22a of the glass substrate 22 on which the irregularities are formed, it is possible to achieve a particularly excellent feel of writing.

### [Configuration of Glass Substrate 22]

Next, the configuration of the glass substrate 22 will be described in detail with reference to FIGS. 1 to 6B.

As described above, the glass substrate 22 is one example of the glass member according to the present invention, and includes the principal surface 22a having the irregularities as shown in FIG. 1.

As shown in FIG. 2, the irregularities mainly include two kinds of irregularities, large and small, i.e., first irregularities and second irregularities.

The first irregularities have an arithmetical mean height Sa1 of 2-500 nm and an mean width RSm1 of roughness curve elements of 2-100 μm.

The second irregularities have an arithmetical mean height Sa2 of 0.7-50 nm, and preferably 0.8 nm or more, 0.9 nm or more, 1.0 nm or more, 1.5 nm or more, 2.0 nm or more, or 2.5 nm or more.

Here, the “arithmetical mean height Sa (Sa1 and Sa2)” is a parameter defined by ISO25178 and is a parameter obtained by extending the contour curve representing the cross-sectional shape of the irregularities in a plane.

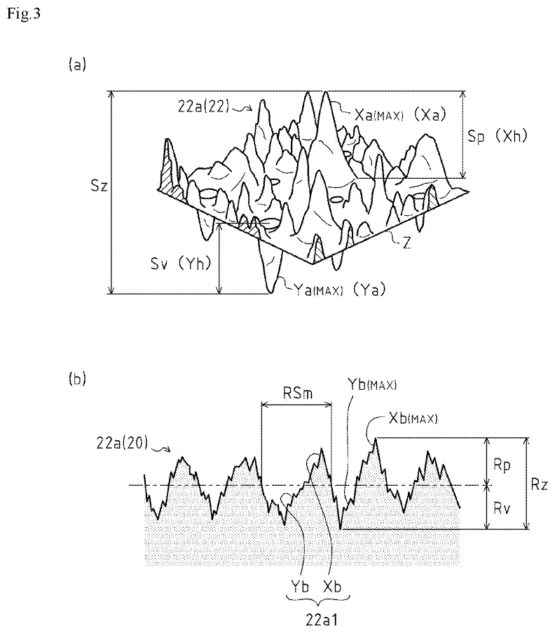

Specifically, as shown in FIG. 3A, the arithmetical mean height Sa represents an average of absolute values of separation distances (for example, a height Xh to a vertex of a peak portion Xa and a depth Yh to a vertex of a valley portion Ya) between each point of the first irregularities and the second irregularities constituting the irregularities with respect to an average plane Z of the principal surface 22a of the glass member 22 (Sa=((Xh₁+Xh₂+ . . . +Xhₙ)+(Yh₁+Yh₂+ . . . +Yhₙ))/2n).

The “mean width RSm (RSm1) of roughness curve elements” is a parameter defined by JISB0601: 2001, and represents an average pitch between concave portions and convex portions adjacent to one another in a contour curve representing a cross-sectional shape of the irregularities.

Specifically, as shown in FIG. 3B, a contour curve representing a cross-sectional shape of the first irregularities is formed by a plurality of continuous undulating curves 22a1, 22a1 . . . and each of the undulating curves 22a1 is constituted of a peak portion Xb and a valley portion Yb adjacent to one another.

Note that the peak portion Xb and the valley portion Yb above each further have a plurality of irregularities, and in a case where these further irregularities do not reach a predetermined threshold (for example, 10% of a maximum height (or a maximum depth) of the peak portion Xb (or the valley portion Yb)), they are regarded as noise and recognized as a part of the peak portion Xb or the valley portion Yb.

The mean width RSm of roughness curve elements is represented by an average length of the plurality of undulating curves 22a1, 22a1 . . . (RSm=(RSm₁+RSm₂+ . . . . RSmₙ)/n).

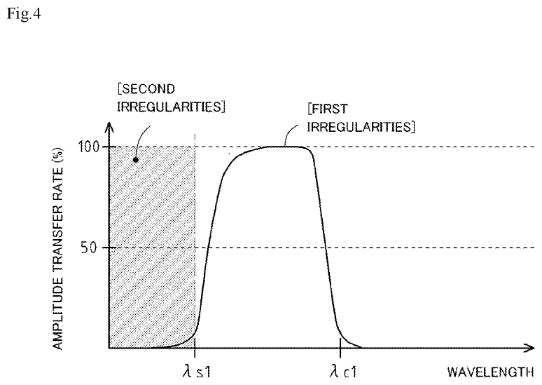

As shown in FIGS. 2 and 4, the values of the mean width RSm1 of the roughness curve elements and the arithmetical mean height Sa1 of the first irregularities are obtained in a case where the cutoff value of a high-pass filter λc1 for cutting off long-wavelength components from a measurement contour curve of the principal surface 22a is set to 14 μm or 50 μm and the cutoff value of a low-pass filter λs1 for cutting off short-wavelength components from a side-turn contour curve of the principal surface 22a is set to 0.35 μm.

The arithmetical mean height Sa2 of the second irregularities is a value obtained in a measurement region which is more microscopic than a setting range of the high-pass filter λc1 and the low-pass filter λs1 of the first irregularities, and in the present application, is a value obtained in a square region with one side measuring 5 μm when it is assumed that the cutoff value of a high-pass filter λc2 is 2.5 μm.

Thus, the irregularities formed on the principal surface 22a of the glass substrate 22 include the first irregularities and the second irregularities which are more microscopic compared to the first irregularities, and the shape of the first irregularities is formed by the continuously connected second irregularities which undulate in a wavy pattern.

In the input display device 1 (see FIG. 1) according to the present embodiment, the shapes of the first and second irregularities on the principal surface 22a of the glass substrate 22 are respectively formed in a scope of the above-described conditions, and thus, the tactile sensation such as the feel of writing with the input pen 2 and the feel of touch with the fingertip 3 can be improved while maintaining the visibility of the display element 10.

Specifically, in a case where an input operation is performed with the input pen 2 on the principal surface 22a, the pen tip 2a of the input pen 2 is neither excessively unlikely to slide nor excessively likely to slide, and thus, it is possible to improve the feel of writing with the input pen 2.

In addition, it is possible to improve the feel of touch with the fingertip 3 without a feel of excessive roughness in a case where an input operation is performed with the fingertip 3 on the principal surface 22a.

Thus, by forming the first irregularities and the second irregularities in an irregular shape within the scope of the above-described conditions, it is possible to suppress the occurrence of glare called sparkling due to the interference of scattered light caused by the irregular shape.

Further, in the present embodiment, since the principal surface 22a of the glass substrate 22 is not provided with a resin layer or the like and the irregular shape is directly formed on the principal surface 22a, the glass substrate 22 has high scratch resistance and is less likely to be scratched, and thus the visibility of the display element 10 is not reduced.

The first irregularities affect the contact between the principal surface 22a of the glass substrate 22 and the input pen 2 or the fingertip 3.

That is, the pen tip 2a of the input pen 2 and the fingertip 3 mainly contact the convex portions of the first irregularities on the principal surface 22a of the glass substrate 22, and hardly contact the concave portions of the irregularities.

That is, since the first irregularities are formed within the scope of the above-described conditions, the contact area between the principal surface 22a of the glass substrate 22 and the input pen 2 or the fingertip 3 can be reduced.

Therefore, in a case where the pen tip 2a of the input pen 2 or the fingertip 3 is moved in contact with the principal surface 22a of the glass substrate 22 on which the irregularities are formed, the friction force generated between the principal surface 22a and the pen tip 2a or the fingertip 3 is repeatedly increased and decreased appropriately.

Therefore, it is possible to prevent an excessive increase or an excessive decrease in the friction force between the pen tip 2a or the fingertip 3 and the principal surface 22a of the glass substrate 22, and it is possible to improve the tactile sensation such as the feel of writing with the input pen 2 or the feel of touch with the fingertip 3.

As described above, in the present embodiment, the upper limit of the mean width RSm1 (see FIG. 2) of the roughness curve elements of the first irregularities is set to 100 μm, but the upper limit is preferably set to 80 μm, more preferably set to 60 μm, still more preferably set to 50 μm, particularly preferably set to 49 μm, 48 μm, 45 μm, 40 μm, 35 μm, 30 μm, and 25 μm, and most preferably set to 20 μm.

In the present embodiment, the lower limit of the mean width RSm1 of the roughness curve elements of the first irregularities is set to 2 μm, but the lower limit is preferably set to 2.5 μm, more preferably set to 3 μm, still more preferably set to 3.5 μm, particularly preferably set to 4 μm, more than 4 μm, 4.5 μm, 5 μm, 6 μm, 7 μm, 8 μm, and 9 μm, and most preferably set to 10 μm.

The reason why the upper limit of the mean widths RSm1 of the roughness curve elements in the first irregularities is set as described above is as follows.

That is, as described above, the mean value of the heights of convex portions in the first irregularities is defined by the arithmetical mean height Sa1, but the value is each a random value.

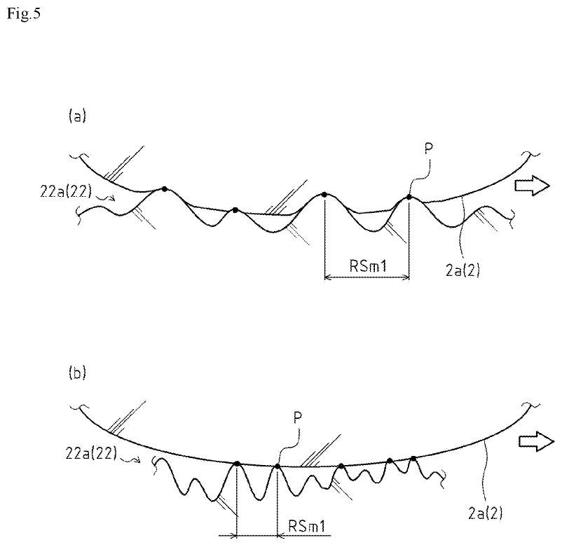

Here, as shown in FIG. 5A, in a case where the upper limit of the mean width RSm1 of the roughness curve elements in the first irregularities exceeds 100 μm, the separation distances between the convex portions adjacent to one another also become longer.

On the other hand, the contact surfaces of the pen tip 2a of the input pen 2 and the fingertip 3 which are in contact with the principal surface 22a of the glass substrate 22 are each formed of a curved surface which is convex toward the principal surface 22a.

Therefore, the contact surface of the pen tip 2a of the input pen 2 or the fingertip 3 is more likely to enter the gaps between the vertexes of the adjacent convex portions, and the contact area in the vicinity of a contact point P between the pen tip 2a of the input pen 2 or the fingertip 3 and the vertexes of the convex portions in the first irregularities inevitably increase.

As a result, the friction force between the pen tip 2a of the input pen 2 or the fingertip 3 and the first irregularities increases, and the tactile sensation such as the feel of writing with the input pen 2 and the feel of touch with the fingertip 3 may be reduced.

In contrast, as shown in FIG. 5B, in the present embodiment, the upper limit of the mean width RSm1 of the roughness curve elements of the first irregularities is set to be within a range of 100 μm or less, and thus, the separation distances between the convex portions adjacent to one another are also appropriately narrowed.

Therefore, the contact surface of the pen tip 2a of the input pen 2 or the fingertip 3 is less likely to enter the gaps between the vertexes of the adjacent convex portions, and the contact area in the vicinity of the contact point P between the pen tip 2a of the input pen 2 or the fingertip 3 and the vertexes of the convex portions of the first irregularities inevitably decrease, and thus, the friction force between the pen tip 2a of the input pen 2 or the fingertip 3 and the first irregularities does not increase, and the tactile sensation such as the feel of writing with the input pen 2 and the feel of touch with the fingertip 3 can be reliably improved.

The second irregularities contribute to the friction force between the pen tip 2a of the input pen 2 or the fingertip 3 and the principal surface 22a of the glass substrate 22.

The contribution of the friction force varies depending on the material of the pen tip 2a.

Specifically, in a case where the pen tip 2a is made of elastomer, the friction force due to adhesion force increases as the principal surface 22a of the glass substrate 22 becomes flatter, and the pen tip 2a is less likely to slide with respect to the principal surface 22a of the glass substrate 22.

Therefore, by providing the second irregularities on the principal surface 22a of the glass substrate 22, the contact area between the principal surface 22a and the pen tip 2a of the input pen 2 can be reduced, and the pen tip 2a can be appropriately more likely to slide with respect to the principal surface 22a of the glass substrate 22.

The pen tip 2a made of elastomer includes a thermosetting elastomer and a thermoplastic elastomer. The thermosetting elastomer includes, for example, a silicone elastomer, and the thermoplastic elastomer includes a styrene elastomer, an olefin elastomer, a polyester elastomer, a polyurethane elastomer, a vinyl chloride elastomer, a polyamide elastomer, and the like.

On the other hand, in a case where the pen tip 2a is made of a hard material such as polyacetal, the friction force decreases as the principal surface 22a of the glass substrate 22 becomes flatter, and the pen tip 2a is more likely to slide with respect to the principal surface 22a of the glass substrate 22.

Therefore, by providing the second irregularities on the principal surface 22a of the glass substrate 22, the pen tip 2a of the input pen 2 is more likely to be caught by the principal surface 22a, the friction force increases, and the pen tip 2a can be appropriately less likely to slide with respect to the principal surface 22a of the glass substrate 22.

in a case where the pen tip 2a is made of a material such as conductive fiber or felt, the pen tip 2a behaves similarly to the above-described pen tip 2a made of polyacetal, and by providing the second irregularities on the principal surface 22a of the glass substrate 22, the pen tip 2a of the input pen 2 is more likely to be caught by the principal surface 22a, the friction force increases, and the pen tip 2a can be appropriately less likely to slide with respect to the principal surface 22a of the glass substrate 22.

The fingertip 3 behaves similarly to the above-described pen tip 2a made of elastomer, and by providing the second irregularities on the principal surface 22a of the glass substrate 22, the contact area of the fingertip 3 with the principal surface 22a can be reduced, and thus, the fingertip 3 can be appropriately more likely to slide and the feel of touch can be improved without the feel of excessive roughness.

Thus, by providing the second irregularities on the principal surface 22a of the glass substrate 22, the pen tip 2a of the input pen 2 made of various materials (elastomers, polyacetals, conductive fibers, and felts) can be appropriately suppressed from sliding on the principal surface 22a, or the difficulty of sliding of the pen tip 2a on the principal surface 22a can be appropriately reduced, and thus, the feel of writing with the input pen 2 can be improved.

In addition, the feel of touch with the fingertip 3 can be improved.

It is preferable that in the second irregularities, the developed interfacial area ratio Sdr2 in a square region with one side measuring 5 μm is 3-60% when it is assumed that the cutoff value of the high-pass filter λc2 is 2.5 μm.

Here, the “developed interfacial area ratio Sdr (Sdr2)” is a parameter defined by ISO25178, as in the case of the arithmetical mean height Sa, and represents the increase in an actual surface area of a defined region with respect to a virtual area of the defined region which is assumed to be a completely flat surface (in the present embodiment, a square region with one side measuring 5 μm).

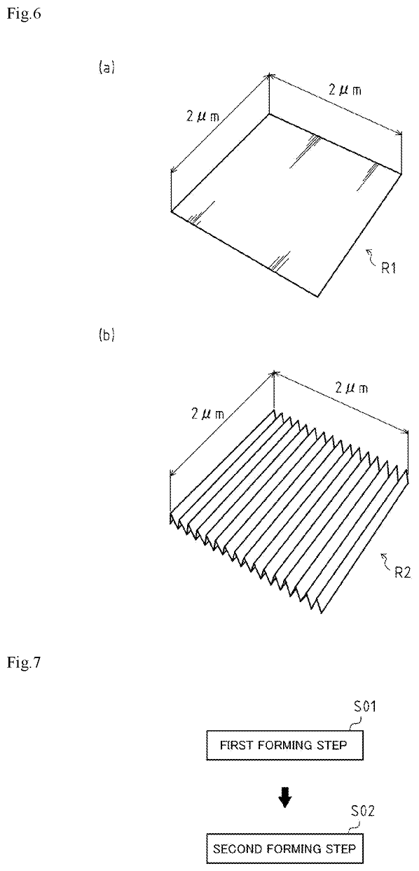

For example, as shown in FIG. 6A, in a case where the actual surface of the defined region R1 is a completely flat surface, the value of the developed interfacial area ratio Sdr is 0.

Further, as shown in FIG. 6B, in a case where the actual surface of the defined region R2 is formed in a corrugated shape including inclination angles of 45°, the value of the developed interfacial area ratio Sdr is 0.414 (about 40%). That is, the surface area of the defined region R2 is increased by about 40% compared to the surface area of the defined region R1.

In this embodiment, in a case where the developed interfacial area ratio Sdr2 is less than 3% on the principal surface 22a of the glass substrate 22, the second irregularities are relatively gentle undulations, and thus, in a case where an input operation is performed with the input pen 2 and the fingertip 3 on the principal surface 22a, the pen tip 2a of the input pen 2 and the fingertip 3 are likely to slide, which may deteriorate the feel of writing with the input pen 2 and the feel of touch with the fingertip 3.

On the other hand, in a case where the developed interfacial area ratio Sdr2 exceeds 60%, the second irregularities become undulations with relatively large height differences, and thus, in a case where an input operation is performed with the input pen 2 and the fingertip 3 on the principal surface 22a, the pen tip 2a of the input pen 2 is less likely to slide, and the fingertip 3 feels excessive roughness, which may deteriorate the feel of writing with the input pen 2 and the feel of touch with the fingertip 3.

Thus, as described above, by setting the developed interfacial area ratio Sdr2 within the range of 3-60%, it is possible to further improve the feel of writing with the input pen 2 and the feel of touch with the fingertip 3.

It is preferable that in the second irregularities, a root mean square gradient Sdq2 in a square region with one side measuring 5 μm is 2-80 when it is assumed that the cutoff value of the high-pass filter λc2 is 2.5 μm.

Here, the “root mean square gradient Sdq (Sdq2)” is a parameter defined by ISO25178, as in the case of the arithmetical mean height Sa and the developed interfacial area ratio Sdr, and is a parameter, which is calculated by a root mean square, of the slopes at all points in the defined region (in the present embodiment, a square region with one side measuring 5 μm).

For example, as shown in FIG. 6A, in a case where the actual surface of the defined region R1 is a completely flat surface, the value of the root mean square gradient Sdq is 0.

Further, as shown in FIG. 6B, in a case where the actual surface of the defined region R2 is formed in a corrugated shape including inclination angles of 45°, the value of the root mean square gradient Sdq is 1.

In this embodiment, in a case where the root mean square gradient Sdq2 is less than 2 on the principal surface 22a of the glass substrate 22, the tip portions of the second irregularities are relatively gentle slopes, and thus, in a case where an input operation is performed with the input pen 2 and the fingertip 3 on the principal surface 22a, the pen tip 2a of the input pen 2 and the fingertip 3 are likely to slide, which may deteriorate the feel of writing with the input pen 2 and the feel of touch with the fingertip 3.

On the other hand, in a case where the root mean square gradient Sdq2 exceeds 80, the tip portions of the second irregularities become sharp and pointed slopes, and thus, in a case where an input operation is performed with the input pen 2 and the fingertip 3 on the principal surface 22a, the pen tip 2a of the input pen 2 is less likely to slide, and the fingertip 3 feels excessive roughness, which may deteriorate the feel of writing with the input pen 2 and the feel of touch with the fingertip 3.

Thus, as described above, by setting the root mean square gradient Sdq2 within the range of 2-80, it is possible to further improve the feel of writing with the input pen 2 and the feel of touch with the fingertip 3.

Further, it is preferable that in the first irregularities, when the cutoff value of the high-pass filter λc1 is 14 μm and the cutoff value of the low-pass filter λs1 is 0.35 μm, a maximum height roughness Rz1 is 25-700 nm.

It is preferable that in the second irregularities, a maximum height Sz2 in a square region with one side measuring 5 μm is 10-400 nm when it is assumed that the cutoff value of the high-pass filter λc2 is 2.5 μm.

Further, it is preferable that in the first irregularities, when the cutoff value of the high-pass filter λc1 is 50 μm and the cutoff value of the low-pass filter λs1 is 0.35 μm, the maximum height roughness Rz1 is 25-1500 nm.

Here, same as the mean width RSm of roughness curve elements, the “maximum height roughness Rz (Rz1)” is a parameter defined by JISB0601: 2001, and is the sum of the height of the highest peak and the depth of the deepest valley in the contour curve showing the cross-sectional shape of the irregularities.

Specifically, as shown in FIG. 3B, the maximum height roughness Rz represents the sum of the absolute values of a height Rp to a vertex of a maximum peak portion Xb (MAX) and a depth Rv to a vertex of a maximum valley portion Yb_{(MAX)} (Rz=Rp+Rv).

Same as the above-described arithmetical mean height Sa, the “maximum height Sz (Sz2)” is a parameter defined by ISO25178 and is a parameter obtained by extending the contour curve representing the cross-sectional shape of the irregularities in a plane.

Specifically, as shown in FIG. 3A, the maximum height Sz represents the sum of the absolute values of a height Sp to a vertex of a maximum peak portion Xa (MAX) and a depth Sv to a vertex of a maximum valley portion Ya (MAX) with respect to the average plane Z of the principal surface 22a of the glass member 22 (Sz=Sp+Sv).

By forming the irregularities on the principal surface 22a of the glass substrate 22 in this manner, in a case where an input operation is performed with the input pen 2 and the fingertip 3 on the principal surface 22a, the friction force transmitted to the pen tip 2a of the input pen 2 and the fingertip 3 through the first irregularities and the second irregularities appropriately repeats increase and decrease, and the feel of writing with the input pen 2 and the feel of touch with the fingertip 3 can be still further improved.

It is more preferable that in the second irregularities, a maximum peak height Sp2 in a square region with one side measuring 5 μm is 6-200 nm when it is assumed that the cutoff value of the high-pass filter λc2 is 2.5 μm.

Here, same as the above-described arithmetical mean height Sa and the maximum height Sz, the “maximum peak height Sp (Sp2)” is a parameter defined by ISO25178 and is a parameter obtained by extending the contour curve representing the cross-sectional shape of the irregularities in a plane.

Specifically, as described above, the maximum peak height Sp represents the height to the vertex of the maximum peak portion Xa (MAX) with respect to the average plane Z of the principal surface 22a of the glass member 22.

In a case where the maximum peak height Sp2 is less than 6 nm, the second irregularities are relatively gentle bulges, and thus, in a case where an input operation is performed with the input pen 2 and the fingertip 3 on the principal surface 22a, the pen tip 2a of the input pen 2 and the fingertip 3 are likely to slide, which may deteriorate the feel of writing with the input pen 2 and the feel of touch with the fingertip 3.

On the other hand, in a case where the maximum peak height Sp2 exceeds 200 nm, the second irregularities become relatively larger bulges, and thus, in a case where an input operation is performed with the input pen 2 and the fingertip 3 on the principal surface 22a, the pen tip 2a of the input pen 2 is less likely to slide, and the fingertip 3 feels excessive roughness, which may deteriorate the feel of writing with the input pen 2 and the feel of touch with the fingertip.

Thus, by setting the maximum peak height Sp2 within the range of 6-200 nm in the irregularities on the principal surface 22a of the glass substrate 22, it is possible to still further improve the feel of writing with the input pen 2 and the feel of touch with the fingertip 3. It is preferable that in FIG. 1, the glass substrate 22 has a haze value, which is an index of transparency and represents cloudiness, of less than 10% in the visible light wavelength range (380 nm to 780 nm) from the viewpoint of visibility of the image of the display element 10 when the image is viewed through the glass substrate 22.

With the haze value of the glass substrate 22 being less than 10%, the transparency of the glass substrate 22 can be maintained, and the visibility of the display element 10 can be maintained.

From the viewpoint of antireflection, the haze value of the glass substrate 22 is preferably less than 60% in the visible light wavelength range (380 nm to 780 nm).

The upper limit of the haze value is preferably 60% or less, more preferably 55% or less, 50% or less, 45% or less, or less than 45%.

With the haze value of the glass substrate 22 being less than 60%, the transparency of the glass substrate 22 can be secured at a certain level, and the visibility of the display element 10 can be maintained at a certain level.

In this case, the lower limit of the haze value is preferably more than 10%, and more preferably 15% or more, 20% or more, 25% or more, 30% or more, or 35% or more.

Further, on the principal surface 22a of the glass substrate 22, an antireflection film for reducing the reflectivity of the side with which the input pen 2 or the fingertip 3 comes into contact and/or an antifouling film for preventing adhesion of a fingerprint and imparting water repellency and oil repellency can be formed.

In a case where the glass substrate 22 is used as a cover member of the input display device 1, the antireflection film is disposed on at least the principal surface 22a of the glass substrate 22 on the front side (the side with which the input pen 2 or the fingertip 3 comes into contact).

In a case where there is a gap between the glass substrate 22 and the display element 10, it is preferable to dispose the antireflection film on a principal surface 22b of the glass substrate 22 on the back side (the display element 10 side).

A low refractive index film having a refractive index lower than that of the glass substrate 22, or a dielectric multilayer film in which a low refractive index film having a relatively low refractive index and a high refractive index film having a relatively high refractive index are alternately stacked, for example, is used as the antireflection film. The antireflection film can be formed by a sputtering method, a CVD method, or the like.

In a case where the principal surface 22a of the glass substrate 22 has the antireflection film, the irregularities of the principal surface 22a of the glass substrate 22 are formed in a manner that the surface irregularities of the antireflection film are in the range of the surface roughness described above (the arithmetical mean height Sa1, the mean width RSm1 of the roughness curve elements, and the maximum height roughness Rz1 of the first irregularities, and the arithmetical mean height Sa2, the developed interfacial area ratio Sdr2, the root mean square gradient Sdq2, the maximum height Sz2, and the maximum peak height Sp2 of the second irregularities).

In a case where the principal surface 22a of the glass substrate 22 has the antireflection film, the irregularities of the principal surface 22a of the glass substrate 22 are formed in a manner that the haze value of the glass substrate 22 having the antireflection film falls within the above-described range.

After the antireflection film is formed, in a case where the arithmetical mean height Sa1 and the mean width RSm1 of the roughness curve elements of the first irregularities, and the arithmetical mean height Sa2 of the second irregularities are to be measured, a Au-film of 10 nm is formed, and then these values are measured.

In a case where the glass substrate 22 is used as the cover member of the input display device 1, the antifouling film is disposed on at least a part of the principal surface 22a (the entire principal surface 22a in the present embodiment) on the front side (the side with which the input pen 2 or the fingertip 3 comes into contact) of the glass substrate 22.

Thus, a glass member laminate 30 including an antifouling layer 23 formed of the antifouling film and the glass substrate 22 can be obtained.

It is preferable that the antifouling film contains an organosilicon compound or a fluorine-containing polymer containing silicon in the chain.

As the fluorine-containing polymer, for example, a polymer having a-Si—O—Si-unit in the main chain and having a fluorine-containing water-repellent functional group in the side chain can be used.

In a case where the principal surface 22a of the glass substrate 22 has the antireflection film and the antifouling film on the front side, the antireflection film is formed on the principal surface 22a of the glass substrate 22, and the antifouling film is formed on the antireflection film.

In a case where the principal surface 22a of the glass substrate 22 has the antifouling film or in a case where the principal surface 22a of the glass substrate 22 has the antireflection film and the antifouling film, the irregularities of the principal surface 22a of the glass substrate 22 are formed in a manner that the surface irregularities of the antifouling film are in the range of the surface roughness described above (the arithmetical mean height Sa1, the mean width RSm1 of the roughness curve elements, and the maximum height roughness Rz1 of the first irregularities, the arithmetical mean height Sa2, the developed interfacial area ratio Sdr2, the root mean square gradient Sdq2, the maximum height Sz2, and the maximum peak height Sp2 of the second irregularities).

In a case where the principal surface 22a of the glass substrate 22 has the antifouling film or in a case where the principal surface 22a of the glass substrate 22 has the antireflection film and the antifouling film, the irregularities of the principal surface 22a of the glass substrate 22 are formed in a manner that the haze value of the glass substrate 22 after the antifouling film is formed or the haze value of the glass substrate 22 after the antireflection film and the antifouling film are formed falls within the above-described range.

### [Method for Manufacturing Glass Member]

Next, a method for manufacturing glass member will be described with reference to FIG. 1 and FIG. 7.

The method for manufacturing glass member embodied by the present embodiment is a method for forming irregularities on at least one principal surface 22a of the glass substrate 22 described above, and as shown in FIG. 7, includes mainly a first forming step S01 and a second forming step S02 which are performed sequentially over time.

The first forming step S01 is a step of forming the first irregularities described above by performing a chemical etching treatment, a silica coating treatment, or the like on the principal surface 22a of the glass substrate 22.

The second forming step S02 is a step of forming the second irregularities described above by performing a wet blast treatment, a sand blast treatment, or the like on the first irregularities formed in the first forming step S01.

The chemical etching treatment in the first forming step S01 is a hydrofluoric acid etching treatment in which the principal surface 22a of the glass substrate 22 is chemically etched by hydrofluoric acid (HF) gas, hydrofluoric acid, or a mixed solution containing hydrofluoric acid.

Further, it is preferable to perform the wet blast treatment or the sand blast treatment prior to the chemical etching treatment. By performing the chemical etching treatment after the wet blast treatment or the sand blast treatment, the size of the irregularities (first irregularities) formed after the chemical etching treatment can be increased.

In the first forming step S01, in a case where the first irregularities are formed by performing the chemical etching treatment after the wet blast treatment or the sand blast treatment, lighter formation of irregularities is sufficient compared to a case where the first irregularities are formed only by the wet blast treatment or the sand blast treatment, and thus, it is less likely to cause breakage or other damage to the glass substrate 22.

Further, when the chemical etching treatment is performed after the pre-formation of the irregularities by the wet blast treatment or the sand blast treatment, a random and highly uniform irregular shape is more likely to be obtained on the principal surface 22a of the glass substrate 22.

In a case where the chemical etching treatment is performed after the wet blast treatment or the sand blast treatment, the surface roughness (the arithmetical mean height Sa1, the mean width RSm1 of the roughness curve elements, and the maximum height roughness Rz1) of the first irregularities formed on the principal surface 22a of the glass substrate 22 can be adjusted by various conditions in the wet blast treatment or the sand blast treatment, such as a grain size distribution of abrasive grains contained in a slurry, and a spraying pressure adjustment when the slurry is sprayed to a workpiece, and various conditions in the chemical etching treatment, i.e., etching treatment time and concentration of a treatment liquid, etc.

Thus, in a case where the chemical etching treatment is performed after the wet blast treatment or the sand blast treatment, the manufacturing conditions can be finely changed, and thus, a desired irregular shape is more likely to be formed, and thus, the controllability of parameters such as the interval and height of the irregularities is improved.

The silica coating treatment is a treatment of applying a coating agent, which contains a matrix precursor such as a silica precursor and a liquid medium which dissolves the matrix precursor, to the principal surface 22a of the glass substrate 22, and heating the coating agent.

The wet blast treatment in the second forming step S02 is a treatment in which abrasive grains constituted of solid particles such as alumina and a liquid such as water are uniformly stirred to form a slurry and then the slurry is sprayed at a high speed from a spray nozzle using compressed air to the principal surface 22a of the glass substrate 22 to form the second irregularities on the principal surface 22a.

In the wet blast treatment, when the slurry sprayed at a high speed is collided with the principal surface 22a of the glass substrate 22, the surface of the principal surface 22a is cut, hit, or rubbed by abrasive grains in the slurry, whereby the second irregularities are formed on the surface of the principal surface 22a.

In this case, the abrasive grains sprayed to the principal surface 22a of the glass substrate 22 and the fragments of the principal surface 22a cut by the abrasive grains are washed away by the liquid sprayed together with the abrasive grains, and thus, the particles remaining on the principal surface 22a of the glass substrate 22 are reduced.

The second irregularities formed on the principal surface 22a of the glass substrate 22 by the wet blast treatment can be adjusted in terms of surface roughness (the arithmetical mean height Sa2, the developed interfacial area ratio Sdr2, the root mean square gradient Sdq2, the maximum height Sz2, and the maximum peak height Sp2) mainly by the grain size distribution of the abrasive grains contained in the slurry and the spray pressure at which the slurry is sprayed to the principal surface 22a of the glass substrate 22.

In the wet blast treatment, in a case where the slurry is sprayed to the principal surface 22a of the glass substrate 22, the abrasive grains are carried to the principal surface 22a by liquid, and thus, compared to a dry sand blast treatment, finer abrasive grains can be used and the impact when the abrasive grains collide with the principal surface 22a of the glass substrate 22 is smaller, and thus, precise processing can be performed.

Thus, in the present embodiment, by performing the wet blast treatment on the principal surface 22a of the glass substrate 22 having the appropriate first irregularities, the appropriate second irregularities can be easily formed on the principal surface 22a, and the feel of writing with the input pen 2 and the feel of touch with the fingertip 3 can be improved without impairing the transparency of the glass substrate 22.

It is also possible to form the second irregularities on the principal surface 22a of the glass substrate 22 by dry sand blast treatment.

As described above, the method for manufacturing glass member embodied by the present embodiment includes the first forming step S01 of forming the first irregularities by performing a hydrofluoric acid etching on the principal surface 22a of the glass substrate 22, and the second forming step S02 of forming the second irregularities by performing the wet blast treatment or the sand blast treatment on the first irregularities formed in the first forming step S01.

With such a configuration, according to the method for manufacturing glass member in the present embodiment, in a case where an input operation is performed with the input pen 2 on the principal surface 22a, the pen tip 2a of the input pen 2 is neither excessively unlikely to slide nor excessively likely to slide, and thus, it is possible to manufacture the glass substrate 22 with an excellent feel of writing with the input pen 2.

In addition, it is possible to manufacture the glass substrate 22 with an excellent feel of touch with the fingertip 3 and without a feel of excessive roughness in a case where an input operation is performed with the fingertip 3 on the principal surface 22a.

### OTHER EMBODIMENTS

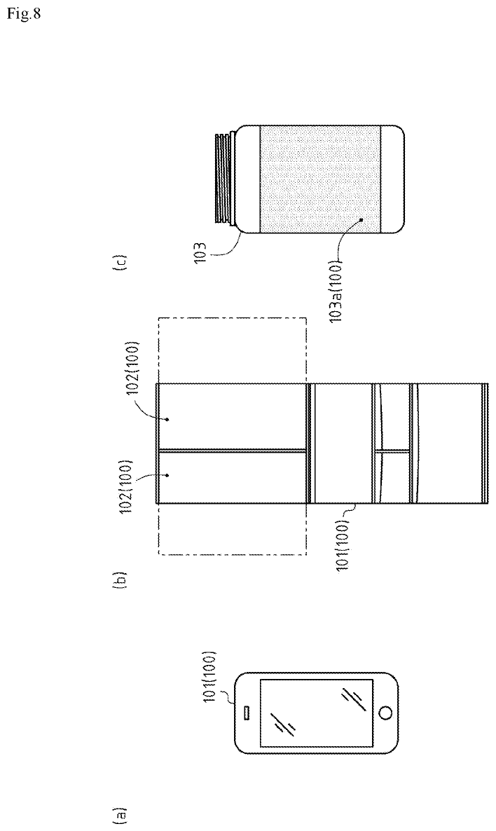

In FIG. 8, the glass substrate 22 or the glass member laminate 30 including the glass substrate 22 and the antifouling layer 23 in the present embodiment can be used as a glass member for exterior use 100 constituting an exterior of an electronic device, mainly focusing on the improvement of the feel of touch with the fingertip 3.

Specifically, the glass member for exterior use 100 can be used as a housing 101 or a door body 102 of the electronic device.

Here, as shown in FIG. 8A, examples of the electronic device having the housing 101 include communication terminals such as a cellular phone, a smartphone, a PDA (Personal Data Assistance), a PND (Portable Navigation Device), and a portable car navigation system, broadcast receivers such as a portable radio, a portable television, and a one segment receiver, and information terminals such as a digital camera, a video camera, a portable music player, a sound recorder, a portable DVD player, a portable game machine, a notebook computer, a tablet PC, an electronic dictionary, an electronic notebook, an electronic book reader, a portable printer, and a portable scanner.

As shown in FIG. 8B, examples of the electronic device including the housing 101 and the door body 102 include household electronic devices such as an electric refrigerator, an electric washing machine, a rice cooker, an IH cooking heater, a vacuum cleaner, an oven range, a microwave oven, an oven toaster, an air cleaner, a dishwasher dryer, an electric pot, and an electric kettle.

As shown in FIG. 8C, the glass member for exterior use 100 can be used on an outer peripheral surface 103a of a container 103 for the purpose of making the container less likely to slip and improving the feel of touch when holding the container by hand.

### EXAMPLES

Next, examples of the glass substrate 22 in which two types of irregularities, large and small, including the first irregularities and the second irregularities are formed on one principal surface 22a will be described in detail with reference to FIG. 1, Tables A1 to A5, and Tables 1 to 8.

The following examples of the glass substrate 22 are merely examples of the glass member according to the present invention, and the glass member is not limited thereto.

### [Preparation of Samples]

First, samples 1-19, 26 and 27 were each prepared as examples of the glass substrate 22, and samples 20-25 were each prepared as comparative examples to these examples.

An alkali-containing aluminosilicate glass having a thickness of 0.55 mm was used as the raw material of the glass substrate 22 in these samples 1-27.

Tables A1 to A5 show the conditions for preparing each glass substrate 22.

TABLE A1

| | | | Examples | | | | | |
|---|---|---|---|---|---|---|---|---|
| | | | No. 1 | No. 2 | No. 3 | No. 4 | No. 5 | No. 6 |
| Irregularities | First step | Grain | Alumina | | | | | |
| A | (forming | Grain size | 4000 | 4000 | 8000 | 4000 | 2000 | 4000 |
| | preliminary | Processing speed [mm/s] | 10 | 10 | 10 | 10 | 5 | 10 |
| | irregularities) | Processing pressure [MPa] | 0.15 | 0.15 | 0.15 | 0.15 | 0.25 | 0.15 |
| | Second step | Concentration of | 5 | 2 | 2 | 2 | 2 | 2 |
| | (first forming | hydrofluoric acid [Wt %] | | | | | | |
| | step S01) | Concentration of sulfuric | 0 | 40 | 40 | 40 | 45 | 50 |
| | | acid [Wt %] | | | | | | |
| | | Pure water [Wt %] | 95 | 58 | 58 | 58 | 53 | 48 |
| | | Processing time [minutes] | 5 | 20 | 20 | 30 | 30 | 20 |

TABLE A2

| | | | Examples | | | | | |
|---|---|---|---|---|---|---|---|---|
| | | | No. 7 | No. 8 | No. 9 | No. 10 | No. 11 | No. 12 |
| Irregularities | First step | Grain | Alumina | | | | | |
| A | (forming | Grain size | 2000 | 4000 | 4000 | 2000 | 2000 | 4000 |
| | preliminary | Processing speed [mm/s] | 10 | 10 | 5 | 10 | 5 | 10 |
| | irregularities) | Processing pressure [MPa] | 0.15 | 0.15 | 0.25 | 0.15 | 0.15 | 0.15 |
| | Second step | Concentration of | 2 | 2 | 2 | 2 | 2 | 2 |
| | (first forming | hydrofluoric acid [Wt %] | | | | | | |
| | step S01) | Concentration of sulfuric | 50 | 45 | 50 | 30 | 30 | 30 |
| | | acid [Wt %] | | | | | | |
| | | Pure water [Wt %] | 48 | 53 | 48 | 68 | 68 | 68 |
| | | Processing time [minutes] | 30 | 30 | 10 | 30 | 10 | 20 |

TABLE A3

| | | | Examples | | | | | |
|---|---|---|---|---|---|---|---|---|
| | | | No. 13 | No. 14 | No. 15 | No. 16 | No. 17 | No. 18 |
| Irregularities | First step | Grain | Alumina | | | | | |
| A | (forming | Grain size | 2000 | 8000 | 2000 | 320 | 320 | 800 |
| | preliminary | Processing speed [mm/s] | 10 | 5 | 10 | 5 | 5 | 5 |
| | irregularities) | Processing pressure [MPa] | 0.15 | 0.15 | 0.25 | 0.15 | 0.10 | 0.15 |
| | Second step | Concentration of | 5 | 2 | 2 | 2 | 2 | 2 |
| | (first forming | hydrofluoric acid [Wt %] | | | | | | |
| | step S01) | Concentration of sulfuric | 0 | 45 | 45 | 40 | 40 | 40 |
| | | acid [Wt %] | | | | | | |
| | | Pure water [Wt %] | 95 | 53 | 53 | 58 | 58 | 58 |
| | | Processing time [minutes] | 15 | 15 | 30 | 30 | 30 | 30 |

TABLE A4

| | | | Examples | Comparative examples | | | | |
|---|---|---|---|---|---|---|---|---|
| | | | No. 19 | No. 20 | No. 21 | No. 22 | No. 23 | No. 24 |
| Irregularities | First step | Grain | Alumina | — | Alumina | | | — |
| A | (forming | Grain size | 800 | — | 8000 | 4000 | 2000 | — |
| | preliminary | Processing speed [mm/s] | 5 | — | 5 | 5 | 5 | — |
| | irregularities) | Processing pressure [MPa] | 0.20 | — | 0.15 | 0.15 | 0.20 | — |
| | Second step | Concentration of | 2 | — | 2 | 2 | 2 | — |
| | (first forming | hydrofluoric acid [Wt %] | | | | | | |
| | step S01) | Concentration of sulfuric | 40 | — | 40 | 40 | 45 | — |
| | | acid [Wt %] | | | | | | |
| | | Pure water [Wt %] | 58 | — | 58 | 58 | 53 | — |
| | | Processing time [minutes] | 30 | — | 20 | 30 | 30 | — |

TABLE A5

| | | | Comparative | | |
|---|---|---|---|---|---|
| | | | examples | Examples | |
| | | | No. 25 | No. 26 | No. 27 |
| Irregularities | First step | Grain | — | — | — |
| A | (forming | Grain size | — | — | — |
| | preliminary | Processing speed [mm/s] | — | — | — |
| | irregularities) | Processing pressure [MPa] | — | — | — |
| | Second step | Concentration of | — | — | — |
| | (first forming | hydrofluoric acid [Wt %] | | | |
| | step S01) | Concentration of sulfuric | — | — | — |
| | | acid [Wt %] | | | |
| | | Pure water [Wt %] | — | — | — |
| | | Processing time [minutes] | — | — | — |

For each glass substrate 22 of samples 1-19 as examples, as described below, the first irregularities (hereinafter, appropriately referred to as “irregularities A”) were prepared in the first forming step S01 (see FIG. 7) including two steps (a first step and a second step to be described below), and then the second irregularities (hereinafter, appropriately referred to as “irregularities B”) were formed on the irregularities A in the second forming step S02 including one step (a third step to be described below), thereby forming the irregularities including the irregularities A and the irregularities B.

### [Formation of Irregularities A]

The irregularities A were formed by the first step and the second step which were sequentially performed over time.

In the first step, a wet blast treatment, in which a slurry were prepared by uniformly stirring pure water and 10-13 vol % of abrasive grains made of alumina having a grain size of #320 to #8000, the entire principal surface 22a of one glass substrate 22 was scanned while moving a nozzle at a processing speed of 5-10 mm/s, and the prepared slurry was sprayed from the nozzle using air at a processing pressure of 0.1-0.25 MPa to the entire principal surface 22a, was performed to form preliminary irregularities Aa.

In the second step, the glass substrate 22 having the preliminary irregularities Aa, which were formed on the principal surface 22a in the first step, was immersed in an etching solution containing 2-5 wt % of hydrofluoric acid, 0-50 wt % of sulphuric acid, and 48-95 wt % of pure water, and left at a liquid temperature of 30° C. for 5-30 minutes to perform an etching treatment, thereby forming the final irregularities A from the preliminary irregularities Aa.

In the first step, the values of the arithmetical mean height Sa1, the mean width RSm1 of the roughness profile elements, and the maximum height roughness Rz1 of the finally formed irregularities A can be increased by increasing the grain size of alumina.

By increasing the processing pressure of the air jetted from the nozzle, the values of the arithmetical mean height Sa1, the mean width RSm1 of the roughness profile elements, and the maximum height roughness Rz1 of the finally formed irregularities A can be increased.

On the other hand, by increasing the processing speed of the nozzle, the values of the arithmetical mean height Sa1, the mean width RSm1 of the roughness profile elements, and the maximum height roughness Rz1 of the finally formed irregularities A can be reduced.

In the second step, the arithmetical mean height Sa1 of the finally formed irregularities A can be reduced by increasing the concentration of the sulfuric acid in the etching solution.

On the other hand, by increasing the standing time for the etching treatment, the mean width RSm1 of the roughness profile elements of the finally formed irregularities A can be increased.

### [Formation of Irregularities B]

The irregularities B were formed in the third step.

In the third step, a wet blast treatment, in which a slurry was prepared by uniformly stirring pure water and 3-13 vol % of abrasive grains made of alumina having a grain size of #2000 to #8000, the principal surface 22a having the irregularities A formed in the first step and the second step described above was scanned while moving a nozzle at a processing speed of 0.1-10 mm/s, and the prepared slurry was sprayed from the nozzle using air at a processing pressure of 0.1-0.25 MPa to the principal surface 22a, was performed to form the irregularities B on the irregularities A.

The abrasive grains used herein have a polygonal shape.

In the third step, the values of the arithmetical mean height Sa2, the developed interfacial area ratio Sdr2, the root mean square gradient Sdq2, the maximum height Sz2, and the maximum peak height Sp2 of the finally formed irregularities B can be increased by increasing the grain size of alumina.

The values of the arithmetical mean height Sa2, the developed interfacial area ratio Sdr2, the root mean square gradient Sdq2, the maximum height Sz2, and the maximum peak height Sp2 of the finally formed irregularities B can be increased by increasing the processing pressure of the air jetted from the nozzle.

On the other hand, the values of the arithmetical mean height Sa2, the developed interfacial area ratio Sdr2, the root mean square gradient Sdq2, the maximum height Sz2, and the maximum peak height Sp2 of the finally formed irregularities B can be reduced by increasing the processing speed of the nozzle.

The glass substrate 22 of sample 20 as a comparative example is not subjected to the treatment on one principal surface 22a.

That is, the glass substrate 22 of sample 20 is not treated.

For the glass substrate 22 of each of samples 21-23 as comparative examples, only the irregularities by the first step and the second step were formed on one principal surface 22a by the same method as that of samples 1-19 described above.

That is, in samples 21-23, only the irregularities A are formed on the principal surface 22a of the glass substrate 22.

For the glass substrate 22 of sample 24 as a comparative example, only the irregularities by the third step were formed on one principal surface 22a by the same method as that of samples 1-15 described above.

That is, in sample 24, only the irregularities B are formed on the principal surface 22a of the glass substrate 22.

For the glass substrate 22 of sample 25 as a comparative example, a liquid containing SiO₂ components was applied to one principal surface 22a by spraying, and the applied liquid containing SiO₂ components was dried to form a SiO₂ coating film on the principal surface 22a.

That is, in sample 25, the principal surface 22a of the glass substrate 22 was subjected to SiO₂ coating.

For the glass substrate 22 of each of samples 26-27 as examples, one principal surface 22a was coated with a resin coating layer having through holes at intervals of 50 μm, and a wet blast processing was performed from above the resin coating layer to form the irregularities A and the irregularities B at the same time using a difference in processing rate between a resin-coated portion and a non-resin-coated portion. After the completion of the processing, the resin coating layer was removed with acetone.

### [Measurement of Surface Roughness]

Next, the surface roughness of the principal surface 22a of the glass substrate 22 of each of samples 1-27 described above was measured.

The measurement of surface roughness was performed on the principal surface 22a having the irregularities A and the irregularities B for samples 1-19, on one principal surface 22a for sample 20, on the principal surface 22a having only the irregularities A for samples 21-23, on the principal surface having only the irregularities B for sample 24, on the principal surface subjected to SiO₂ coating for sample 25, and on the principal surface 22a having the irregularities A and the irregularities B for samples 26-27.

The parameters of the surface roughness to be measured are the arithmetical mean height Sa1, the mean width RSm1 of the roughness profile elements, and the maximum height roughness Rz1 for the irregularities A, and these parameters were measured using a white interference microscope.

As the white interference microscope, a white interference microscope New View 7300 manufactured by Zygo Corporation was used.

### <Measurement A-1>

As the measurement condition of the irregularities A, a 50× objective lens and a 2× zoom lens were used, and the camera pixel count is 640×480 and the number of integration times is 10 for a measurement area of 74×55 μm.

When the arithmetical mean height Sa1, the mean width RSm1 of the roughness profile elements, and the maximum height roughness Rz1 of the irregularities A were measured, the cutoff value of the high-pass filter λc1 was set to 14 μm, and the cutoff value of the low-pass filter λs1 was set to 0.35 μm. <Measurement A-2>

Further, the measurement region was set in the same manner as described above, the cutoff value of the high-pass filter λc1 was set to 50 μm, the cutoff value of the low-pass filter λs1 was set to 0.35 μm, and the arithmetical mean height Sa1, the mean width RSm1 of the roughness profile elements, and the maximum height roughness Rz1 of the irregularities A were measured.

On the other hand, the parameters of the surface roughness to be measured of the irregularities B are the arithmetical mean height Sa2, the developed interfacial area ratio Sdr2, the root mean square gradient Sdq2, the maximum height Sz2, and the maximum peak height Sp2, and these parameters were measured using an atomic force microscope (AFM).

As the atomic force microscope, an atomic force microscope Dimension Icon (SPM unit) and Nano Scope V (Controller unit) manufactured by Bruker Corporation was used, and the measurement was performed based on ISO 25178.

As the measurement condition of the irregularities B, a tapping mode was used, and a scan rate is 1 Hz and a number of acquired pieces of data corresponds to 512×512 for a measurement area of 5×5 μm.

Thereafter, based on the acquired data, each parameter described above of the surface roughness was measured in a square region with one side measuring 5 μm.

The cutoff value of the high-pass filter λc2 was set to 2.5 μm, and an analysis was performed.

### [Measurement Result of Surface Roughness]

The measurement results of the surface roughness of samples 1-27 measured by the measurement method described above are shown in Tables 1 to 8.

TABLE 1

| | | | Examples | | | | | |
|---|---|---|---|---|---|---|---|---|
| | | Cut-off value | | | No. 1 | No. 2 | No. 3 | No. 4 |
| Parameters | Irregularities | <A-1> | Sa1 | [nm] | 106.6 | 79.0 | 35.5 | 9.8 |
| of surface | A | Cutoff value of high-pass | Rz1 | [nm] | 455.4 | 423.3 | 227.3 | 56.5 |
| roughness | | filter λc1 is 14 μm | Rsm1 | [μm] | 11.1 | 15.5 | 7.8 | 7.4 |
| | | Cutoff value of low-pass | | | | | | |
| | | filter λs1 is 0.35 μm | | | | | | |
| | | <A-2> | Sa1 | [nm] | 118.0 | 123.5 | 39.0 | 12.4 |
| | | Cutoff value of high-pass | Rz1 | [nm] | 511.1 | 544.9 | 308.3 | 90.2 |
| | | filter λc1 is 50 μm | Rsm1 | [μm] | 12.3 | 14.0 | 5.0 | 9.7 |
| | | Cutoff value of low-pass | | | | | | |
| | | filter λs1 is 0.35 μm | | | | | | |
| | Irregularities | Cutoff value of high-pass | Sa2 | [nm] | 11.3 | 11.1 | 13.7 | 11.5 |
| | B | filter λc2 is 2.5 μm | Sz2 | [nm] | 131.0 | 137.0 | 206.0 | 130.0 |
| | | No cutoff of low-pass | Sp2 | [nm] | 41.5 | 39.3 | 42.8 | 43.7 |

| | | | | | |
|---|---|---|---|---|---|
| filter λs1 | Sdq2 | 30.9 | 27.5 | 29.8 | 30.4 |

| | | | | | |
|---|---|---|---|---|---|
| Sdr2 | [%] | 15.0 | 12.3 | 14.6 | 15.4 |

| | | | | | |
|---|---|---|---|---|---|
| Haze value | [%] | 24.7 | 25.5 | 10.1 | 1.3 |

| | | | | | |
|---|---|---|---|---|---|
| Result of | Feel of writing | ◯ | ⊙ | ⊙ | ⊙ |
| sensory | Feel of touch | ⊙ | ⊙ | ⊙ | ◯ |
| evaluation | Visibility | ⊙ | ⊙ | ⊙ | ⊙ |
| | Reflection | ⊙ | ⊙ | ◯ | X |

TABLE 2

| | | | Examples | | | | | |
|---|---|---|---|---|---|---|---|---|
| | | Cut-off value | | | No. 5 | No. 6 | No. 7 | No. 8 |
| Parameters | Irregularities | <A-1> | Sa1 | [nm] | 13.6 | 20.3 | 16.1 | 18.2 |
| of surface | A | Cutoff value of high-pass | Rz1 | [nm] | 65.8 | 110.3 | 67.3 | 86.2 |
| roughness | | filter λc1 is 14 μm | Rsm1 | [μm] | 14.2 | 8.3 | 13.0 | 7.9 |
| | | Cutoff value of low-pass | | | | | | |
| | | filter λs1 is 0.35 μm | | | | | | |
| | | <A-2> | Sa1 | [nm] | 23.0 | 28.3 | 41.7 | 24.8 |
| | | Cutoff value of high-pass | Rz1 | [nm] | 153.1 | 162.1 | 162.9 | 130.0 |
| | | filter λc1 is 50 μm | Rsm1 | [μm] | 21.8 | 10.7 | 17.9 | 9.1 |
| | | Cutoff value of low-pass | | | | | | |
| | | filter λs1 is 0.35 μm | | | | | | |
| | Irregularities | Cutoff value of high-pass | Sa2 | [nm] | 12.7 | 7.1 | 4.9 | 8.9 |
| | B | filter λc2 is 2.5 μm | Sz2 | [nm] | 179.0 | 122.0 | 87.5 | 111.0 |
| | | No cutoff of low-pass | Sp2 | [nm] | 45.7 | 38.2 | 30.2 | 36.7 |

| | | | | | |
|---|---|---|---|---|---|
| filter λs1 | Sdq2 | 30.5 | 19.0 | 16.8 | 20.2 |

| | | | | | |
|---|---|---|---|---|---|
| Sdr2 | [%] | 15.1 | 5.7 | 4.4 | 8.4 |

| | | | | | |
|---|---|---|---|---|---|
| Haze value | [%] | 1.2 | 2.5 | 1.4 | 2.4 |

| | | | | | |
|---|---|---|---|---|---|
| Result of | Feel of writing | ⊙ | ⊙ | ⊙ | ⊙ |
| sensory | Feel of touch | ◯ | ◯ | ◯ | ◯ |
| evaluation | Visibility | ⊙ | ⊙ | ⊙ | ⊙ |
| | Reflection | X | Δ | Δ | Δ |

TABLE 3

| | | | Examples | | | | | |
|---|---|---|---|---|---|---|---|---|
| | | Cut-off value | | | No. 9 | No. 10 | No. 11 | No. 12 |
| Parameters | Irregularities | <A-1> | Sa1 | [nm] | 22.0 | 79.7 | 164.3 | 58.0 |
| of surface | A | Cutoff value of high-pass | Rz1 | [nm] | 89.4 | 288.1 | 548.4 | 196.3 |
| roughness | | filter λc1 is 14 μm | Rsm1 | [μm] | 7.3 | 14.3 | 12.3 | 12.0 |
| | | Cutoff value of low-pass | | | | | | |
| | | filter λs1 is 0.35 μm | | | | | | |
| | | <A-2> | Sa1 | [nm] | 23.7 | 109.8 | 190.5 | 69.0 |
| | | Cutoff value of high-pass | Rz1 | [nm] | 137.9 | 457.3 | 756.8 | 249.6 |
| | | filter λc1 is 50 μm | Rsm1 | [μm] | 9.5 | 17.5 | 14.9 | 14.2 |
| | | Cutoff value of low-pass | | | | | | |
| | | filter λs1 is 0.35 μm | | | | | | |
| | Irregularities | Cutoff value of high-pass | Sa2 | [nm] | 12.7 | 16.1 | 25.2 | 16.7 |
| | B | filter λc2 is 2.5 μm | Sz2 | [nm] | 165.0 | 155.0 | 261.0 | 137.0 |
| | | No cutoff of low-pass | Sp2 | [nm] | 38.4 | 55.7 | 101.0 | 42.8 |

| | | | | | |
|---|---|---|---|---|---|
| filter λs1 | Sdq2 | 23.8 | 26.8 | 40.0 | 29.6 |

| | | | | | |
|---|---|---|---|---|---|
| Sdr2 | [%] | 11.2 | 16.5 | 26.0 | 14.3 |

| | | | | | |
|---|---|---|---|---|---|
| Haze value | [%] | 3.4 | 18.3 | 49.8 | 11.3 |

| | | | | | |
|---|---|---|---|---|---|
| Result of | Feel of writing | ⊙ | ⊙ | ◯ | ⊙ |
| sensory | Feel of touch | ◯ | ⊙ | ⊙ | ⊙ |
| evaluation | Visibility | ⊙ | ⊙ | ⊙ | ⊙ |
| | Reflection | Δ | ◯ | ⊙ | ◯ |

TABLE 4

| | | | Examples | | | | | |
|---|---|---|---|---|---|---|---|---|
| | | Cut-off value | | | No. 13 | No. 14 | No. 15 | No. 16 |
| Parameters | Irregularities | <A-1> | Sa1 | [nm] | 118.3 | 46.0 | 16.2 | 66.1 |
| of surface | A | Cutoff value of high-pass | Rz1 | [nm] | 415.2 | 241.8 | 56.6 | 330.9 |
| roughness | | filter λc1 is 14 μm | Rsm1 | [μm] | 13.0 | 5.5 | 8.7 | 19.3 |
| | | Cutoff value of low-pass | | | | | | |
| | | filter λs1 is 0.35 μm | | | | | | |
| | | <A-2> | Sa1 | [nm] | 163.2 | 47.0 | 17.3 | 226.1 |
| | | Cutoff value of high-pass | Rz1 | [nm] | 654.8 | 278.5 | 89.7 | 1174.2 |
| | | filter λc1 is 50 μm | Rsm1 | [μm] | 16.8 | 6.1 | 9.9 | 40.2 |
| | | Cutoff value of low-pass | | | | | | |
| | | filter λs1 is 0.35 μm | | | | | | |
| | Irregularities | Cutoff value of high-pass | Sa2 | [nm] | 11.1 | 8.1 | 30.7 | 5.8 |
| | B | filter λc2 is 2.5 μm | Sz2 | [nm] | 132.0 | 90.3 | 283.0 | 93.5 |
| | | No cutoff of low-pass | Sp2 | [nm] | 39.0 | 28.1 | 106.0 | 32.1 |

| | | | | | |
|---|---|---|---|---|---|
| filter λs1 | Sdq2 | 27.4 | 23.4 | 43.7 | 17.5 |

| | | | | | |
|---|---|---|---|---|---|
| Sdr2 | [%] | 11.7 | 8.2 | 37.8 | 4.8 |

| | | | | | |
|---|---|---|---|---|---|
| Haze value | [%] | 24.3 | 10.5 | 1.2 | 43.0 |

| | | | | | |
|---|---|---|---|---|---|
| Result of | Feel of writing | ◯ | ◯ | ⊙ | ◯ |
| sensory | Feel of touch | ⊙ | ◯ | ◯ | ⊙ |
| evaluation | Visibility | ⊙ | ⊙ | ⊙ | ⊙ |
| | Reflection | ⊙ | ◯ | X | ⊙ |

TABLE 5

| | | | Examples | | | | |
|---|---|---|---|---|---|---|---|
| | | Cut-off value | | | No. 17 | No. 18 | No. 19 |
| Parameters | Irregularities | <A-1> | Sa1 | [nm] | 50.2 | 33.1 | 37.6 |
| of surface | A | Cutoff value of high-pass | Rz1 | [nm] | 197.4 | 300.5 | 187.9 |
| roughness | | filter λc1 is 14 μm | Rsm1 | [μm] | 17.2 | 17.1 | 14.8 |
| | | Cutoff value of low-pass | | | | | |
| | | filter λs1 is 0.35 μm | | | | | |
| | | <A-2> | Sa1 | [nm] | 163.7 | 89.7 | 123.6 |
| | | Cutoff value of high-pass | Rz1 | [nm] | 651.2 | 326.6 | 702.8 |
| | | filter λc1 is 50 μm | Rsm1 | [μm] | 23.5 | 22.8 | 31.2 |
| | | Cutoff value of low-pass | | | | | |
| | | filter λs1 is 0.35 μm | | | | | |
| | Irregularities | Cutoff value of high-pass | Sa2 | [nm] | 12.1 | 15.4 | 8.5 |
| | B | filter λc2 is 2.5 μm | Sz2 | [nm] | 151.1 | 153.5 | 102.4 |
| | | No cutoff of low-pass | Sp2 | [nm] | 44.6 | 53.4 | 32.9 |

| | | | | |
|---|---|---|---|---|
| filter λs1 | Sdq2 | 30.4 | 24.8 | 21.5 |

| | | | | |
|---|---|---|---|---|
| Sdr2 | [%] | 15.3 | 15.8 | 8.3 |

| | | | | |
|---|---|---|---|---|
| Haze value | [%] | 36.7 | 24.8 | 16.7 |

| | | | | |
|---|---|---|---|---|
| Result of | Feel of writing | ◯ | ⊙ | ◯ |
| sensory | Feel of touch | ⊙ | ⊙ | ⊙ |
| evaluation | Visibility | ⊙ | ⊙ | ⊙ |

TABLE 6

| | | | Comparative Examples | | | | |
|---|---|---|---|---|---|---|---|
| | | Cut-off value | | | No. 20 | No. 21 | No. 22 |
| Parameters | Irregularities | <A-1> | Sa1 | [nm] | 0.1 | 36.7 | 10.7 |
| of surface | A | Cutoff value of high-pass | Rz1 | [nm] | 0.8 | 211.5 | 70.8 |
| roughness | | filter λc1 is 14 μm | Rsm1 | [μm] | 0.9 | 4.7 | 6.1 |
| | | Cutoff value of low-pass | | | | | |
| | | filter λs1 is 0.35 μm | | | | | |
| | | <A-2> | Sa1 | [nm] | 0.1 | 38.0 | 14.0 |
| | | Cutoff value of high-pass | Rz1 | [nm] | 0.9 | 236.5 | 78.8 |
| | | filter λc1 is 50 μm | Rsm1 | [μm] | 1.4 | 5.1 | 8.7 |
| | | Cutoff value of low-pass | | | | | |
| | | filter λs1 is 0.35 μm | | | | | |
| | Irregularities | Cutoff value of high-pass | Sa2 | [nm] | 0.2 | 0.5 | 0.5 |
| | B | filter λc2 is 2.5 μm | Sz2 | [nm] | 1.4 | 6.4 | 7.2 |
| | | No cutoff of low-pass | Sp2 | [nm] | 0.7 | 3.6 | 4.2 |

| | | | | |
|---|---|---|---|---|
| filter λs1 | Sdq2 | 0.5 | 2.2 | 3.2 |

| | | | | |
|---|---|---|---|---|
| Sdr2 | [%] | 0.005 | 0.1 | 0.2 |

| | | | | |
|---|---|---|---|---|
| Haze value | [%] | — | 9.6 | 1.0 |

| | | | | |
|---|---|---|---|---|
| Result of | Feel of writing | X | X | X |
| sensory | Feel of touch | X | X | X |
| evaluation | Visibility | ⊙ | ⊙ | ⊙ |
| | Reflection | X | ◯ | X |

TABLE 7

| | | | Comparative Examples | | | | |
|---|---|---|---|---|---|---|---|
| | | Cut-off value | | | No. 23 | No. 24 | No. 25 |
| Parameters | Irregularities | <A-1> | Sa1 | [nm] | 14.3 | 2.3 | 71.6 |
| of surface | A | Cutoff value of high-pass | Rz1 | [nm] | 51.0 | 24.8 | 595.7 |
| roughness | | filter λc1 is 14 μm | Rsm1 | [μm] | 10.8 | 1.9 | 6.5 |
| | | Cutoff value of low-pass | | | | | |
| | | filter λs1 is 0.35 μm | | | | | |
| | | <A-2> | Sa1 | [nm] | 17.1 | 2.8 | 118.3 |
| | | Cutoff value of high-pass | Rz1 | [nm] | 99.6 | 26.7 | 716.3 |
| | | filter λc1 is 50 μm | Rsm1 | [μm] | 9.2 | 1.9 | 11.6 |
| | | Cutoff value of low-pass | | | | | |
| | | filter λs1 is 0.35 μm | | | | | |
| | Irregularities | Cutoff value of high-pass | Sa2 | [nm] | 0.6 | 4.7 | 0.6 |
| | B | filter λc2 is 2.5 μm | Sz2 | [nm] | 8.2 | 79.5 | 7.6 |
| | | No cutoff of low-pass | Sp2 | [nm] | 5.1 | 34.5 | 4.8 |

| | | | | |
|---|---|---|---|---|
| filter λs1 | Sdq2 | 3.3 | 15.7 | 2.8 |

| | | | | |
|---|---|---|---|---|
| Sdr2 | [%] | 0.2 | 4.2 | 0.2 |

| | | | | |
|---|---|---|---|---|
| Haze value | [%] | 0.9 | 0.4 | 47.6 |

| | | | | |
|---|---|---|---|---|
| Result of | Feel of writing | X | Δ | X |
| sensory | Feel of touch | X | Δ | X |
| evaluation | Visibility | ⊙ | ⊙ | Δ |
| | | | X | ⊙ |

TABLE 8

| | | | | Examples | |
|---|---|---|---|---|---|
| | | Cut-off value | | No. 26 | No. 27 |
| Parameters | Irregularities | Cutoff value of high-pass filter | Sa1 [nm] | 4.8 | 5.1 |
| of surface | A | λc1 is 80 (50 * 1.6) μm | Rz1 [nm] | 10 | 10 |
| roughness | | Cutoff value of low-pass filter | Rsm1 [μm] | 50 | 51 |
| | | λs1 is 25 μm | | | |
| | | <A-1> Measurement conditions | Sa1 [nm] | 4.6 | 5 |
| | | of present application | Rz1 [nm] | 10 | 10 |
| | | Cutoff value of high-pass filter | Rsm1 [μm] | 50 | 50 |
| | | λc1 is 14 μm | | | |
| | | Cutoff value of low-pass filter | | | |
| | | λs1 is 0.35 μm | | | |
| | | <A-2> | Sa1 [nm] | 4.6 | 4.9 |
| | | Cutoff value of high-pass filter | Rz1 [nm] | 9 | 9 |
| | | λc1 is 50 μm | Rsm1 [μm] | 50 | 50 |
| | | Cutoff value of low-pass filter | | | |
| | | λs1 is 0.35 μm | | | |
| | Irregularities | Cutoff value of high-pass filter | Sa2 [nm] | 5.2 | 4.0 |
| | B | λc2 is 25 μm | Sz2 [nm] | — | — |
| | | No cutoff of low-pass filter λs1 | Sp2 [nm] | — | — |
| | | | Sdq2 | — | — |
| | | | Sdr2 [%] | — | — |
| | | <Measurement conditions of | Sa2 [nm] | 10.7 | 11.8 |
| | | present application> | Sz2 [nm] | 128.0 | 135.0 |
| | | Cutoff value of high-pass filter | Sp2 [nm] | 42.8 | 44.1 |
| | | λc2 is 2.5 μm | Sdq2 | 29.8 | 30.8 |
| | | No cutoff of low-pass filter λs1 | Sdr2 [%] | 15.1 | 15.6 |
| | | | Rsm2 [μm] | 3.5 | 3.4 |

| | | | |
|---|---|---|---|
| Haze value | [%] | 1.2 | 1.2 |

| | | | |
|---|---|---|---|
| Result of | Feel of writing | ◯ | ◯ |
| sensory | Feel of touch | ◯ | ◯ |
| evaluation | Visibility | ⊙ | ⊙ |
| | Reflection | X | X |

### <Measurement A-1>

As shown in Tables 1 to 8, in samples 1-19, 26, and 27 as examples, the arithmetical mean height Sa1 of the irregularities A is a numerical value within a range of 4.6-164.3 nm, the maximum height roughness Rz1 is a numerical value within a range of 10-548.4 nm, and the mean width RSm1 of the roughness profile elements is a numerical value within a range of 5.5-50 μm.

In contrast, in samples 20-25 as comparative examples, the arithmetical mean height Sa1 is 0.1 nm, the maximum height roughness Rz1 is 0.8 nm, and the mean width RSm1 of the roughness profile elements is 0.9 μm in the irregularities A of sample 20 which is not treated, and these numerical values are all considerably smaller than those of samples 1-19 as examples.

In samples 21-23 which are provided only with the irregularities A, the arithmetical mean height Sa1 of the irregularities A is a numerical value within a range of 10.7-36.7 nm, the maximum height roughness Rz1 of the irregularities A is a numerical value within a range of 51.0-211.5 nm, and the mean width RSm1 of the roughness profile elements of the irregularities A is a numerical value within a range of 4.7-10.8 μm.

In sample 24 which was provided only with the irregularities B, the arithmetical mean height Sa1 obtained by the above-described measurement method of the irregularities A is 2.3 nm, the maximum height roughness Rz1 is 24.8 nm, and the mean width RSm1 of the roughness profile elements is 1.9 μm.

In sample 25 subjected to SiO₂ coating, the arithmetical mean height Sa1 of the irregularities A is 71.6 nm, the maximum height roughness Rz1 of the irregularities A is 595.7 nm, and the mean width RSm1 of the roughness profile elements of the irregularities A is 6.5 μm.

### <Measurement A-2>

As shown in Tables 1 to 8, in samples 1-19, 26, and 27 as examples, the arithmetical mean height Sa1 of the irregularities A is a numerical value within a range of 4.6-226.1 nm, the maximum height roughness Rz1 of the irregularities A is a numerical value within a range of 10-1174.2 nm, and the mean width RSm1 of the roughness profile elements of the irregularities A is a numerical value within a range of 5.0-50 μm.

In contrast, in samples 20-25 as comparative examples, the arithmetical mean height Sa1 is 0.1 nm, the maximum height roughness Rz1 is 0.9 nm, and the mean width RSm1 of the roughness profile elements is 1.4 μm in the irregularities A of sample 20 which is not treated, and these numerical values are all considerably smaller than those of samples 1-19 as examples.

In samples 21-23 which are provided only with the irregularities A, the arithmetical mean height Sa1 of the irregularities A is a numerical value within a range of 14.0-38.0 nm, the maximum height roughness Rz1 is a numerical value within a range of 78.8-236.5 nm, and the mean width RSm1 of the roughness profile elements is a numerical value within a range of 5.1-9.2 μm.

In sample 24 which is provided only with the irregularities B, the arithmetical mean height Sa1 obtained by the above-described measurement method of the irregularities A is 2.8 nm, the maximum height roughness Rz1 is 26.7 nm, and the mean width RSm1 of the roughness profile elements is 1.9 μm.

In sample 25 subjected to SiO₂ coating, the arithmetical mean height Sa1 of the irregularities A is 118.3 nm, the maximum height roughness Rz1 of the irregularities A is 716.3 nm, and the mean width RSm1 of the roughness profile elements of the irregularities A is 11.6 μm.

On the other hand, as shown in Tables 1 to 8, in samples 1-19, 26, and 27 as examples, the arithmetical mean height Sa2 of the irregularities B is a numerical value within a range of 4.9-30.7 nm.

In contrast, in samples 20-25 as comparative examples, the arithmetical mean height Sa2 of sample 20, which is not treated, is 0.2 nm, the arithmetical mean height Sa2 of samples 21-23 having only the irregularities A is a numerical value within a range of 0.5-0.6 nm, the arithmetical mean height Sa2 of sample 24 having only the irregularities B is 4.7 nm, and the arithmetical mean height Sa2 of sample 25 subjected to SiO₂ coating is 0.6 nm.

In addition, in samples 1-19, 26, and 27 as examples, the maximum height Sz2 of the irregularities B is a numerical value within a range of 87.5 to 283.0 nm.

In contrast, in samples 20-25 as comparative examples, the maximum height Sz2 of sample 20, which is not treated, is 1.4 nm, the maximum height Sz2 of samples 21-23 having only the irregularities A is a numerical value within a range of 6.4-8.2 nm, and the maximum height Sz2 of sample 25 subjected to SiO₂ coating is 7.6 nm, and these numerical values are all considerably smaller than those of samples 1-19 as examples.

The arithmetical mean height Sz2 of sample 24 having only the irregularities B is 79.5 nm.

In samples 1-19, 26, and 27 as examples, the maximum peak height Sp2 of the irregularities B is a numerical value within a range of 28.1-106.0 nm.

In contrast, in samples 20-25 as comparative examples, the maximum peak height Sp2 of sample 20, which is not treated, is 0.7 nm, the maximum peak height Sp2 of samples 21-23 having only the irregularities A is a numerical value within a range of 3.6-5.1 nm, and the maximum peak height Sp2 of sample 25 subjected to SiO₂ coating is 4.8 nm, and these numerical values are all considerably smaller than those of samples 1-19 as examples. The maximum peak height Sp2 of sample 24 having only the irregularities B is 34.5 nm.

In samples 1-19, 26, and 27 as examples, the root mean square gradient Sdq2 of the irregularities B is a numerical value within a range of 16.8-43.7.

In contrast, in samples 20-27 as comparative examples, the root mean square gradient Sdq2 of sample 20, which is not treated, is 0.5, the root mean square gradient Sdq2 of samples 21-23 having only the irregularities A is a numerical value within a range of 2.2-3.3, the root mean square gradient Sdq2 of sample 24 having only the irregularities B is 15.7, and the root mean square gradient Sdq2 of sample 25 subjected to SiO₂ coating is 2.8, and these numerical values are all smaller than those of samples 1-19 as examples.

Further, in samples 1-19, 26, and 27 as examples, the developed interfacial area ratio Sdr2 of the irregularities B is a numerical value within a range of 4.4-37.8.

In contrast, in samples 20-25 as comparative examples, the developed interfacial area ratio Sdr2 of sample 20, which is not treated, is 0.005, the developed interfacial area ratio Sdr2 of samples 21-23 having only the irregularities A is a numerical value within a range of 0.1-0.2, the developed interfacial area ratio Sdr2 of sample 24 having only the irregularities B is 4.2, and the developed interfacial area ratio Sdr2 of sample 25 subjected to SiO₂ coating is 0.2, and these numerical values are all smaller than those of samples 1-15 as examples.

### [Measurement of Haze]

Next, the haze of each of samples 1-27 was measured. The haze was measured using an ultraviolet-visible-near-infrared spectrophotometer (UV 3100PC) manufactured by Shimadzu Corporation based on JIS K7361-1-1997.

### [Evaluation Result of Haze]

The results of the haze measurement performed on samples 1-27 are shown in Tables 1 to 4 described above in the same manner.

As shown in Tables 1 to 8, the haze values of samples 1-19, 26, and 27 as examples are numerical values within a range of 1.2-49.8.

In contrast, in samples 20-25 as comparative examples, the haze value of sample 20, which is not treated, is extremely low and unmeasurable, the haze value of samples 21-23 having only the irregularities A is a numerical value within a range of 0.9-9.6, the haze value of sample 24 having only the irregularities B is 0.4, and the haze value of sample 25 subjected to SiO₂ coating is 47.6.

### [Sensory Evaluation of Feel of Writing]

Next, for samples 1-27, the feel of writing when the character “&” is input on the principal surface 22a of each glass substrate 22 using the input pen 2 is evaluated by a sensory test.

As an evaluation method, a replacement lead manufactured by Wacom Co., Ltd. (product name: ACK-20004, diameter of pen tip: 1.4 mm) having the pen tip 2a made of elastomer is inserted into a jig manufactured by a 3D printer and attached to a housing of a ball pen (product name: JETSTREAM) manufactured by Mitsubishi Pencil co. ltd. to be used as the input pen 2 to evaluate the feel of writing on the principal surface 22a of the glass substrate 22.

The evaluation is based on four evaluation criteria, that is, “feel of writing is good: ⊙”, “feel of writing is relatively good: ◯”, “feel of writing is rather bad: Δ”, and “feel of writing is bad: x”.

### [Evaluation Result of Feel of Writing]

The evaluation result of the feel of writing of samples 1-27 is shown in Tables 1 to 8 described above in the same manner.

As shown in Tables 1 to 8, in samples 1-19, 26, and 27 as examples, as the feel of writing of the input pen 2 having the pen tip 2a made of elastomer, the evaluation of “feel of writing is good: ⊙” or “feel of writing is relatively good: ◯” can be obtained.

In contrast, in samples 20-25 as comparative examples, the evaluation result of sample 20, which is not treated, is “feel of writing is bad: x”, the evaluation result of samples 21-23 having only the irregularities A is “feel of writing is bad: x”, the evaluation result of sample 24 having only the irregularities B is “feel of writing is rather bad: Δ”, and the evaluation result of sample 25 subjected to SiO₂ coating is “feel of writing is bad: x”, and thus, good evaluation result cannot be obtained in any of these samples.

### [Sensory Evaluation of Feel of Touch]

Next, the feel of touch with the fingertip 3 is evaluated for samples 1-27 by sensory evaluation.

As an evaluation method, each glass substrate 22 is placed on a desk with the principal surface 22a facing upward, and the feel of touch is evaluated when the fingertip 3 of an index finger is slid on the principal surface 22a a plurality of times.

When each sample was evaluated, the index finger was wiped with ethanol before the evaluation of each sample and the evaluation was started after 1 minute in order to keep the state of the fingertip 3 constant.

The evaluation is based on four evaluation criteria, that is, “feel of touch is good: ⊙”, “feel of touch is relatively good: ◯”, “feel of touch is rather bad: Δ”, and “feel of touch is bad: x”

### [Evaluation Result of Feel of Touch]

The evaluation result of the feel of touch of samples 1-27 is shown in Tables 1 to 8 described above in the same manner.

As shown in Tables 1 to 8, in samples 1-19, 26, and 27 as examples, as the feel of touch of the fingertip 3 of the index finger, the evaluation of “feel of touch is good: ⊙” or “feel of touch is relatively good: ◯” can be obtained.

In contrast, in samples 20-25 as comparative examples, the evaluation result of sample 20, which is not treated, is “feel of touch is bad: x”, the evaluation result of samples 21-23 having only the irregularities A is “feel of touch is bad: x”, the evaluation result of sample 24 having only the irregularities B is “feel of touch is rather bad: Δ”, and the evaluation result of sample 25 subjected to SiO₂ coating is “feel of touch is bad: x”, and thus, good evaluation result cannot be obtained in any of these samples.

### [Sensory Evaluation of Visibility]

Next, visibility is evaluated for samples 1-27 by sensory evaluation.

As an evaluation method, each glass substrate 22 is placed on an ipad pro manufactured by Apple Inc. with the monitor power turned on and the principal surface 22a facing upward, and whether or not characters and images displayed on the screen can be clearly confirmed by visual observation is evaluated using the following determination criteria.

The evaluation is based on four evaluation criteria, that is, “visibility is good: ⊙” “visibility is relatively good: ◯”, “visibility is rather bad: Δ”, and “visibility is bad: x”

### [Evaluation Result of Visibility]

The evaluation result of the visibility of samples 1-27 is shown in Tables 1 to 8 described above in the same manner.

As shown in Tables 1 to 8, in samples 1-19, 26, and 27 as examples, the visibility evaluation of “visibility is good: ⊙” can be obtained.

In contrast, in samples 20-25 as comparative examples, the evaluation result of sample 20, which is not treated, is “visibility is good: ⊙”, the evaluation result of samples 21-23 having only the irregularities A is “visibility is good: ⊙”, the evaluation result of sample 24 having only the irregularities B is “visibility is good: ⊙”, and the evaluation result of sample 25 subjected to SiO₂ coating is “visibility is rather bad: Δ”.

### [Sensory Evaluation of Reflection]

Next, reflection is evaluated for samples 1-27 by sensory evaluation.

As an evaluation method, each glass substrate 22 is placed on an ipad pro manufactured by Apple Inc. with the principal surface 22a facing upward in a room with fluorescent lamps installed on the roof to evaluate, using the evaluation items shown below, whether the reflection of the evaluator himself/herself on the glass substrate 22 due to light reflection interferes with the observation of the image displayed on the ipad pro screen when viewed from the direction perpendicular to the glass substrate 22 with the monitor power of the ipad pro turned on.

The evaluation is based on four evaluation criteria, that is, “reflection is not noticeable at all: ⊙”, “reflection is observed but is not noticeable: ◯”, “reflection is rather noticeable: Δ”, and “reflection is noticeable: x”

[Evaluation result of reflection]

The evaluation result of the reflection of samples 1-27 is shown in Tables 1 to 8 described above in the same manner.

As shown in Tables 1 to 8, in samples 1-19, 26, and 27 as examples, various reflection evaluations of “reflection is not noticeable at all: ⊙”, “reflection is observed but is not noticeable: ◯”, “reflection is rather noticeable: Δ”, and “reflection is noticeable: x” are obtained.

In samples 20-25 as comparative examples, the evaluation result of sample 20, which is not treated, is “reflection is noticeable: x”, the evaluation result of samples 21-23 having only the irregularities A is “reflection is observed but is not noticeable: ◯” or “reflection is noticeable: x”, the evaluation result of sample 24 having only the irregularities B is “reflection is noticeable: x”, and the evaluation result of sample 25 subjected to SiO₂ coating is “reflection is not noticeable at all: ⊙”.

### [Overall Evaluation of Samples]

From the above results, as shown in Tables 1 to 8, in samples 1-19, 26, and 27 as examples, the appropriate irregularities A (that is, the first irregularities described above) and irregularities B (that is, the second irregularities described above) formed on the principal surface 22a with which the pen tip 2a of the input pen 2 comes into contact repeat an appropriate increase and decrease in the friction force between the pen tip 2a and the principal surface 22a, and thus, good evaluation result of feel of writing can be obtained.

In addition, in samples 1-19, 26, and 27 as examples, the contact area between the fingertip 3 and the principal surface 22a is reduced by the appropriate irregularities A (first irregularities) and irregularities B (second irregularities) formed on the principal surface 22a with which the fingertip 3 comes into contact, and the fingertip 3 can be more likely to slide, and thus, good evaluation result of feel of touch can be obtained.

Further, in each of samples 1-19, 26, and 27 as examples, an appropriate haze value was obtained by the appropriate irregularities A (first irregularities) and irregularities B (second irregularities) formed on the principal surface 22a, and thus, the image through the surface could maintain sufficient visibility. On the other hand, there are various variations in the evaluation result of reflection from good to bad, and thus, it is desirable to use a different evaluation result as necessary in accordance with the installation environment and the needs of the user.

On the other hand, in sample 20 as a comparative example, which is not treated, the irregularities formed on the principal surface 22a with which the pen tip 2a of the input pen 2 comes into contact are small, and the pen tip 2a made of elastomer is much less likely to slide, and thus, the evaluation result of the feel of writing is bad.

In sample 20 as the comparative example, which is not treated, the irregularities formed on the principal surface 22a with which the fingertip 3 comes into contact are small, and the fingertip 3 is much less likely to slide, and thus, the evaluation result of the feel of touch is bad.

In sample 20 as the comparative example, which is not treated, the irregularities formed on the principal surface 22a are small, and thus, the visibility is good, but the evaluation result of the reflection is bad.

In samples 21-23 as comparative examples having only the irregularities A (first irregularities), the irregularities formed on the principal surface 22a with which the pen tip 2a of the input pen 2 comes into contact are large, and the pen tip 2a made of elastomer is much less likely to slide, and thus, the evaluation result of the feel of writing is bad.

In samples 21-23 as comparative examples having only the irregularities A (first irregularities), the irregularities formed on the principal surface 22a with which the fingertip 3 comes into contact are large, and the contact area between the fingertip 3 and the principal surface 22a of the glass substrate 22 is not sufficiently reduced, and thus, the fingertip 3 is much less likely to slide, and the evaluation result of the feel of touch is bad.

In samples 21-23 as comparative examples having only the irregularities A (first irregularities), the irregularities formed on the principal surface 22a are large and the visibility is good, but the evaluation result of the reflection is good or bad.

In sample 24 as a comparative example having only the irregularities B (second irregularities), the irregularities formed on the principal surface 22a with which the pen tip 2a of the input pen 2 comes into contact are small, and the pen tip 2a made of elastomer is slightly more likely to slide, but the irregularities A (first irregularities) are not present and the reduction in the contact area is not sufficient, and thus, the feel of writing is not sufficiently improved, and the evaluation result is bad.

In sample 24 as the comparative example having only the irregularities B (second irregularities), the irregularities formed on the principal surface 22a with which the fingertip 3 comes into contact are small, and the fingertip 3 is slightly more likely to slide on the principal surface 22a of the glass substrate 22, but the irregularities A (first irregularities) are not present and the reduction in the contact area is not sufficient, and thus, the fingertip 3 is still less likely to slide, and the evaluation result of the feel of writing is bad.

In sample 24 as the comparative example having only the irregularities B (second irregularities), the irregularities A (first irregularities) are not present, the visibility is good, and the evaluation result of the reflection is bad.

In sample 25 as a comparative example subjected to SiO₂ coating, the irregularities formed on the principal surface 22a with which the pen tip 2a of the input pen 2 comes into contact are large, and the pen tip 2a made of elastomer is much less likely to slide, and thus, the evaluation result of the feel of writing is bad.

In sample 25 as the comparative example subjected to SiO₂ coating, the irregularities formed on the principal surface 22a with which the fingertip 3 comes into contact are large, and the contact area between the fingertip 3 and the principal surface 22a of the glass substrate 22 is not sufficiently reduced, and thus, the fingertip 3 is much less likely to slide, and the evaluation result of the feel of touch is bad.

In sample 25 as the comparative example subjected to SiO₂ coating, the irregularities formed on the principal surface 22a are large, the visibility is poor, and the evaluation result of the reflection is good.

Although the embodiments of the present application have been described above, the present application is not limited to these embodiments in any way, but are merely illustrative, and various more aspects, of course, may be implemented without departing from the gist of the present application, and the scope of the present application is indicated by the claims, and further includes the meaning of equivalents recited in the claims and all changes within the scope.

### REFERENCE SIGNS LIST

10 display element (display device)
20 input device
21 digitizer circuit (detection circuit)
22 glass substrate (glass member)
22a principal surface
23 antifouling layer
30 glass member laminate
100 glass member for exterior use
101 housing
102 door body
103 container
S01 first forming step
S02 second forming step

1. A glass member having a principal surface with irregularities, the irregularities including:
first irregularities in which an arithmetical mean height Sa1 is 2-500 nm and an mean width RSm1 of roughness profile elements is 2-100 μm when a cutoff value of a high-pass filter λc1 is assumed to be 14 μm and a cutoff value of a low-pass filter λs1 is assumed to be 0.35 μm; and
second irregularities in which an arithmetical mean height Sa2 in a square region with one side measuring 5 μm is 0.7-50 nm when a cutoff value of a high-pass filter λc2 is assumed to be 2.5 μm.

2. The glass member according to claim 1, wherein in the first irregularities, when the cutoff value of the high-pass filter λc1 is 14 μm and the cutoff value of the low-pass filter λs1 is 0.35 μm, a maximum height roughness Rz1 is 25-700 nm.

3. A glass member having a principal surface with irregularities, the irregularities including:
first irregularities in which an arithmetical mean height Sa1 is 2-500 nm and an mean width RSm1 of roughness profile elements is 2-100 μm when a cutoff value of a high-pass filter λc1 is assumed to be 50 μm and a cutoff value of a low-pass filter λs1 is assumed to be 0.35 μm; and
second irregularities in which an arithmetical mean height Sa2 in a square region with one side measuring 5 μm is 0.7-50 nm when a cutoff value of a high-pass filter λc2 is assumed to be 2.5 μm.

4. The glass member according to claim 23, wherein in the first irregularities, when the cutoff value of the high-pass filter λc1 is 50 μm and the cutoff value of the low-pass filter λs1 is 0.35 μm, a maximum height roughness Rz1 is 25-1500 nm.

5. The glass member according to claim 1, wherein in the second irregularities, a developed interfacial area ratio Sdr2 in a square region with one side measuring 5 μm is 3-60% when the cutoff value of the high-pass filter λc2 is assumed to be 2.5 μm.

6. The glass member according to claim 1, wherein in the second irregularities, a root mean square gradient Sdq2 in a square region with one side measuring 5 μm is 2-80 when the cutoff value of the high-pass filter λc2 is assumed to be 2.5 μm.

7. The glass member according to claim 1, wherein in the second irregularities, a maximum height Sz2 in a square region with one side measuring 5 μm is 10-400 nm when the cutoff value of the high-pass filter λc2 is assumed to be 2.5 μm.

8. The glass member according to claim 1, wherein in the second irregularities, a maximum peak height Sp2 in a square region with one side measuring 5 μm is 6-200 nm when the cutoff value of the high-pass filter λc2 is assumed to be 2.5 μm.

9. A glass member laminate comprising:
the glass member according to claim 1; and
an antifouling layer that is provided on at least a part of the principal surface of the glass member.

10. An input device comprising:
the glass member according to claim 1; and
a detection circuit that detects an input position.

11. An input display device comprising:
the input device according to claim 10; and
a display device.

12. A glass member for exterior use constituted of the glass member according to claim 1.

13. A housing comprising the glass member for exterior use according to claim 12.

14. A door body comprising the glass member for exterior use according to claim 12.

15. A container comprising the glass member for exterior use according to claim 12.

16. A method for manufacturing the glass member according to claim 1, the method comprising:
a first forming step of forming the first irregularities by performing a hydrofluoric acid etching on the principal surface of the glass member; and
a second forming step of forming the second irregularities by performing a wet blast treatment or a sand blast treatment on the first irregularities formed in the first forming step.

17. The glass member according to claim 3, wherein in the second irregularities, a developed interfacial area ratio Sdr2 in a square region with one side measuring 5 μm is 3-60% when the cutoff value of the high-pass filter λc2 is assumed to be 2.5 μm.

18. The glass member according to claim 3, wherein in the second irregularities, a root mean square gradient Sdq2 in a square region with one side measuring 5 μm is 2-80 when the cutoff value of the high-pass filter λc2 is assumed to be 2.5 μm.

19. The glass member according to claim 3, wherein in the second irregularities, a maximum height Sz2 in a square region with one side measuring 5 μm is 10-400 nm when the cutoff value of the high-pass filter λc2 is assumed to be 2.5 μm.

20. The glass member according to claim 3, wherein in the second irregularities, a maximum peak height Sp2 in a square region with one side measuring 5 μm is 6-200 nm when the cutoff value of the high-pass filter λc2 is assumed to be 2.5 μm.

21. A glass member laminate comprising:
the glass member according to claim 3; and
an antifouling layer that is provided on at least a part of the principal surface of the glass member.

22. An input device comprising:
the glass member according to claim 3; and
a detection circuit that detects an input position.

23. An input display device comprising:
the input device according to claim 22; and
a display device.

24. A glass member for exterior use constituted of the glass member according to claim 3.

25. A housing comprising the glass member for exterior use according to claim 24.

26. A door body comprising the glass member for exterior use according to claim 24.

27. A container comprising the glass member for exterior use according to claim 24.

28. A method for manufacturing the glass member according to claim 3, the method comprising:
a first forming step of forming the first irregularities by performing a hydrofluoric acid etching on the principal surface of the glass member; and
a second forming step of forming the second irregularities by performing a wet blast treatment or a sand blast treatment on the first irregularities formed in the first forming step.
